(19) United States
(12) Patent Application Publication
(10) Pub. No.: US 2009/0207325 A1
(43) Pub. Date: Aug. 20, 2009

(54) Algorithm for SLM of single hinge type

(76) Inventors: Naoya Sugimoto, Tokyo (JP); Yoshihiro Maeda, Tokyo (JP); Fusao Ishii, Menlo Park, CA (US)

Correspondence Address: Bo-In Lin, 13445 Mandoli Drive, Los Altos Hills, CA, 94022, US

(21) Appl. No.: 12/381,581

(22) Filed: Mar. 12, 2009

Related U.S. Application Data
(63) Continuation-in-part of application No. 12/072,448, filed on Feb. 25, 2008.
Application No. 12/072,448 is a continuation-in-part of application No. 11/121,543, filed on May 4, 2005, now Pat. No. 7,268,932.
Application No. 11/121,543 is a continuation-in-part of application No. 10/698,620, filed on Nov. 1, 2003.
Application No. 10/698,620 is a continuation-in-part of application No. 10/699,140, filed on Nov. 1, 2003, now Pat. No. 6,862,127.
Application No. 10/699,140 is a continuation-in-part of application No. 10/699,143, filed on Nov. 1, 2003, now Pat. No. 6,903,860.
(60) Provisional application No. 61/069,298, filed on Mar. 13, 2008.

(51) Int. Cl. H04N 5/74

(52) U.S. Cl. 348/750; 348/E05.137

(57) ABSTRACT

The present invention provides a spatial light modulator, comprising: a pixel array comprising a plurality of pixel elements; a plurality of word lines each connected to a row of pixel elements; a plurality of plate lines; and a plurality of bit lines each connected to a column of pixel elements, wherein each of the pixel elements further comprises a memory and an electrode connected to the memory, wherein the memory is connected to the word line and the word line is further connected to the plate line.

### CROSS REFERENCE OF RELATED APPLICATIONS

This application is a Non-provisional Application of a Provisional Application 61/069,298 filed on Mar. 13, 2008 and a Continuation in Part Application a patent application Ser. No. 12/072,448 filed on Feb. 26, 2008 and a Continuation in Part Application of another Non-provisional patent application Ser. No. 11/121,543 filed on May 4, 2005 issued into U.S. Pat. No. 7,268,932 and another Non-provisional application Ser. No. 10/698,620 filed on Nov. 1, 2003. The application Ser. No. 11/121,543 is a Continuation In Part (CIP) Application of three previously filed applications. These three applications are Ser. No. 10/698,620 filed on Nov. 1, 2003, Ser. No. 10/699,140 filed on Nov. 1, 2003 now issued into U.S. Pat. No. 6,862,127, and Ser. No. 10/699,143 filed on Nov. 1, 2003 now issued into U.S. Pat. No. 6,903,860 by the Applicant of this patent applications. The disclosures made in these patent applications are hereby incorporated by reference in this patent application.

### BACKGROUND OF THE INVENTION

1. Field of the Invention

The present invention relates to the image projection apparatus implemented with a spatial light modulator. More particularly, this invention relates to an image projection apparatus implemented with a spatial light modulator with new and improved configurations to provide additional modulation control to increase the gray scale levels and to improve the image quality displayed by the projection apparatus.

2. Description of the Related Art

After the dominance of CRT technology in the display industry for over 100 years, Flat Panel Display (FPD) and Projection Display have gained popularity because of their space efficiency and larger screen size. Projection displays using micro-display technology are gaining popularity among consumers because of their high picture quality and lower cost. There are two types of micro-displays used for projection displays in the market. One is micro-LCD (Liquid Crystal Display) and the other is micro-mirror technology. Because a micro-mirror device uses un-polarized light, it produces better brightness than micro-LCD, which uses polarized light.

Although significant advances have been made in technologies of implementing electromechanical micro-mirror devices as spatial light modulators, there are still limitations in their high quality images display. Specifically, when display images are digitally controlled, image quality is adversely due to an insufficient number of gray scales.

Electromechanical micro-mirror devices have drawn considerable interest because of their application as spatial light modulators (SLMs). A spatial light modulator requires an array of a relatively large number of micro-mirror devices. In general, the number of required devices ranges from 60,000 to several million for each SLM. Referring to FIG. 1A, an image display system 1 including a screen 2 is disclosed in a relevant U.S. Pat. No. 5,214,420. A light source 10 is used to generate light beams to project illumination for the display images on the display screen 2. The light 9 projected from the light source is further concentrated and directed toward lens 12 by way of mirror 11. Lenses 12, 13 and 14 form a beam columnator operative to columnate the light 9 into a column of light 8. A spatial light modulator 15 is controlled by a computer through data transmitted over data cable 18 to selectively redirect a portion of the light from path 7 toward lens 5 to display on screen 2. FIG. 1B shows a SLM 15 that has a surface 16 that includes an array of switchable reflective elements 17, 27, 37, and 47, each of these reflective elements is attached to a hinge 30. When the element 17 is in an ON position, a portion of the light from path 7 is reflected and redirected along path 6 to lens 5 where it is enlarged or spread along path 4 to impinge on the display screen 2 to form an illuminated pixel 3. When the element 17 is in an OFF position, the light is reflected away from the display screen 2 and, hence, pixel 3 is dark.

The on-and-off states of the micromirror control scheme, as that implemented in the U.S. Pat. No. 5,214,420 and in most conventional display systems, impose a limitation on the quality of the display. Specifically, applying the conventional configuration of a control circuit limits the gray scale gradations produced in a conventional system (PWM between ON and OFF states), limited by the LSB (least significant bit, or the least pulse width). Due to the ON-OFF states implemented in the conventional systems, there is no way of providing a shorter pulse width than the duration represented by the LSB. The least quantity of light, which determines the gray scale, is the light reflected during the least pulse width. The limited levels of the gray scale lead to a degradation of the display image.

Specifically, FIG. 1C exemplifies, as related disclosures, a circuit diagram for controlling a micromirror according to U.S. Pat. No. 5,285,407. The control circuit includes memory cell 32. Various transistors are referred to as “M*” where “*” designates a transistor number and each transistor is an insulated gate field effect transistor. Transistors M5, and M7 are p-channel transistors; transistors, M6, M8, and M9 are n-channel transistors. The capacitances, C1 and C2, represent the capacitive loads in the memory cell 32. The memory cell 32 includes an access switch transistor M9 and a latch 32a based on a Static Random Access switch Memory (SRAM) design. All access transistors M9 on a Row line receive a DATA signal from a different Bit-line 31a. The particular memory cell 32 is accessed for writing a bit to the cell by turning on the appropriate row select transistor M9, using the ROW signal functioning as a Word-line. Latch 32a consists of two cross-coupled inverters, M5/M6 and M7/M8, which permit two stable states that include a state 1 when is Node A high and Node B low, and a state 2 when Node A is low and Node B is high.

The control circuit positions the micro-mirrors to be at either an ON or an OFF angular orientation, as that shown in FIG. 1A. The brightness, i.e., the number of gray scales of display for a digitally control image system, is determined by the length of time the micro-mirror stays at an ON position. The length of time a micromirror is in an ON position is controlled by a multiple bit word. FIG. 1D shows the “binary time intervals” when controlling micromirrors with a four-bit word. As shown in FIG. 1D, the time durations have relative values of 1, 2, 4, 8, which in turn define the relative brightness for each of the four bits where “1” is the least significant bit and “8” is the most significant bit. According to the control mechanism as shown, the minimum controllable differences between gray scales for showing different levels of brightness is a represented by the “least significant bit” that maintains the micromirror at an ON position.

For example, assuming n bits of gray scales, one time frame is divided into 2″−1 equal time periods. For a 16.7-millisecond frame period and n-bit intensity values, the time period is 16.7/(2″−1) milliseconds.

Having established these times for each pixel of each frame, pixel intensities are quantified such that black is a 0 time period, the intensity level represented by the LSB is 1 time period, and the maximum brightness is 2″-1 time periods. Each pixel's quantified intensity determines its ON-time during a time frame. Thus, during a time frame, each pixel with a quantified value of more than 0 is ON for the number of time periods that correspond to its intensity. The viewer's eye integrates the pixel brightness so that the image appears the same as if it were generated with analog levels of light.

For controlling deflectable mirror devices, the PWM applies data to be formatted into “bit-planes”, with each bit-plane corresponding to a bit weight of the intensity of light. Thus, if the brightness of each pixel is represented by an n-bit value, each frame of data has the n-bit-planes. Then, each bit-plane has a 0 or 1 value for each mirror element. According to the PWM control scheme described in the preceding paragraphs, each bit-plane is independently loaded and the mirror elements are controlled according to bit-plane values corresponding to the value of each bit during one frame. Specifically, the bit-plane according to the LSB of each pixel is displayed for 1 time period.

Meanwhile, higher levels of resolution and higher grades of gray scales required for better quality display images are in demand for projection apparatuses, especially in recent years due to the increased availability of video images, such as that provided by high definition television (HDTV) broadcasting.

However, in the gray scale control by the pulse width modulation (PWM), as shown in FIG. 1D, the expressible gray scale is limited by the length of the time period determined by the LSB. An attempt to add a new control structure to a memory cell of the above described SRAM structure in order to overcome the aforementioned limitation creates another problem, that is, the structure of a complex memory cell, with a larger number of transistors than, for example, the memory cell of a DRAM structure, further increases the size of the mechanism.

Specifically, in order to obtain a higher definition display image, a large number of mirror elements are required. Each of these mirror elements, comprising an SRAM-structured memory cell, must be reduced in size to fit in the space of a certain mounting size (e.g., a predefined package size or chip size). However, the addition of a new control structure to an SRAM-structured memory cell in order to attain a higher level gray scale display image increases the size of the memory cell, thereby inhibiting a higher level display image.

### SUMMARY OF THE INVENTION

One aspect of the present invention is to provide new configuration and control process to control the spatial light modulator implemented in an image projection apparatus to achieve a higher level of definition and a higher grade of gray scale of a projection image such that the above discussed limitations and difficulties can be resolved.

A first exemplary embodiment of the present invention provides a spatial light modulator, comprising a pixel array comprising a plurality of pixel elements; a plurality of word lines each connected to a row of pixel elements; a plurality of plate lines; and a plurality of bit lines each connected to a column of pixel elements, wherein each of the pixel elements further comprises a memory and an electrode connected to the memory, wherein the memory is connected to the word line and connected to the plate line.

A second exemplary embodiment of the present invention provides the spatial light modulator according to the first exemplary embodiment, wherein the memory includes a capacitor including a first plate and a second plate in a pair wherein the first plate of the capacitor connected to the electrode and the second plate connected to the plate line.

A third exemplary embodiment of the present invention provides the spatial light modulator according to the first exemplary embodiment, wherein the memory includes a plurality of capacitors, each capacitor comprises a pair of a first plate and a second plate with the first plate connected to the electrode and the second plate of a first group of capacitors connected to a fixed potential and the second plate of a second group of the capacitors connector to the plate line.

A fourth exemplary embodiment of the present invention provides the spatial light modulator according to the first exemplary embodiment, wherein the plate line is activate during a period when the memory is not receiving data from the word line for storing in the memory.

A fifth exemplary embodiment of the present invention provides the spatial light modulator according to the first exemplary embodiment, wherein a Coulomb force generated from activating the electrode by signals transmitted through the plate line is smaller than a Coulomb force generated from activating the electrode by signals transmitted through the bit line.

A sixth exemplary embodiment of the present invention provides the spatial light modulator according to the first exemplary embodiment, wherein each of the pixel elements is controllable to operate in mutually different first and second states and a third state as an intermediate state between the first and second states, wherein a Coulomb force generated by activating the electrode by signals transmitted through the plate line is applied only to control the pixel element operated in the third state and having no effect in operating in the first state or the second state.

A seventh exemplary embodiment of the present invention provides the spatial light modulator according to the first exemplary embodiment, wherein the plate line is controlled to repeatedly activate and deactivate during a period when the memory is not receiving data from the word line for storing in the memory.

An eighth exemplary embodiment of the present invention provides the spatial light modulator according to the first exemplary embodiment, wherein the plate line is deactivate during a period when the memory is receiving data from the word line for storing in the memory.

A ninth exemplary embodiment of the present invention provides the spatial light modulator according to any one of the first exemplary embodiment through sixth exemplary embodiment, wherein each of said pixel elements comprises a mirror controllable to tilt to different directions by generating a Coulomb force by applying a voltage to the electrode.

A tenth exemplary embodiment of the present invention provides the spatial light modulator according to any one of the first exemplary embodiment through sixth exemplary embodiment, wherein the area of the electrode is larger than one half of the area of the pixel element.

An eleventh exemplary embodiment of the present invention provides the mirror array device according to any one of the first exemplary embodiment through sixth exemplary embodiment, wherein the first and second plates of the capacitor further comprising a first and a second electrode plates composed of aluminum.

A twelfth exemplary embodiment of the present invention provides the mirror array device according to any one of the first exemplary embodiment through sixth exemplary embodiment, wherein the first and second plates of the capacitor further comprising a first and a second electrodes plates wherein at least one of said electrode plates comprises a polysilicon plate.

A thirteenth exemplary embodiment of the present invention provides the spatial light modulator according to any one of the first exemplary embodiment through sixth exemplary embodiment, wherein the memory includes a transistor having an area larger than one half of the area of the pixel element.

A fourteenth exemplary embodiment of the present invention provides a spatial light modulator, comprising: a plurality of pixel elements configured as a pixel array; a plurality of word lines each connected to a row of pixel elements; a plurality of plate lines; and a plurality of bit lines each connected to a column of pixel elements, wherein each of the pixel elements further comprises a memory connected to a first electrode and said plate line connected to a second electrode.

A fifteenth exemplary embodiment of the present invention provides the spatial light modulator according to the fourteenth exemplary embodiment, the pixel elements comprising the second electrode connected to the plate line are disposed along a row in a direction along the word line.

A sixteenth exemplary embodiment of the present invention provides the spatial light modulator according to the fourteenth exemplary embodiment, wherein a Coulomb force generated from activating the first electrode connected to the memory is larger than a Coulomb force generated from activating the second electrode connected to the plate line.

A seventeenth exemplary embodiment of the present invention provides the spatial light modulator according to the fourteenth exemplary embodiment, wherein the pixel elements are controlled to operate in mutually different first and second states and a third state as an intermediate state between the first and second states, wherein a Coulomb force generated by activating the second electrode by signals transmitted through the plate line is applied only to control the pixel element operated in the third state and having no effect in operating in the first state or the second state.

An eighteenth exemplary embodiment of the present invention provides the spatial light modulator according to the fourteenth exemplary embodiment, wherein the plate line is deactivate during a period when the memory is receiving data from the word line for storing in the memory.

A nineteenth exemplary embodiment of the present invention provides the spatial light modulator according to the fourteenth exemplary embodiment, wherein the plate line is activated straddling a period when the memory is receiving data from the word line for storing in the memory.

A twentieth exemplary embodiment of the present invention provides the spatial light modulator according to any one of the fourteenth exemplary embodiment through seventeenth exemplary embodiment, wherein each of said pixel elements comprises a mirror controllable to tilt to different directions by generating a Coulomb force by applying a voltage to the first and/or second electrode.

A twenty-first exemplary embodiment of the present invention provides the spatial light modulator according to any one of the fourteenth exemplary embodiment through seventeenth exemplary embodiment, wherein the total of the area of the first and second electrodes is larger than one half of the area of the pixel element.

A twenty-second exemplary embodiment of the present invention provides the spatial light modulator according to any one of the fourteenth exemplary embodiment through seventeenth exemplary embodiment, wherein the memory includes a pair of plates composed of an aluminum constituting a capacitor for the memory.

A twenty-third exemplary embodiment of the present invention provides the spatial light modulator according to any one of the fourteenth exemplary embodiment through seventeenth exemplary embodiment, wherein the memory includes a pair polysilicon layers constituting a capacitor.

A twenty-fourth exemplary embodiment of the present invention provides the spatial light modulator according to any one of the fourteenth exemplary embodiment through seventeenth exemplary embodiment, wherein the memory includes a transistor having an area larger than one half of an area of the pixel element.

### BRIEF DESCRIPTION OF THE DRAWINGS

The present invention is described in detail below with reference to the following Figures.

FIG. 1A illustrates the basic principle of a projection display using a micromirror device, as disclosed in a prior art patent.

FIG. 1B is a top view diagram showing the configuration of mirror elements of a portion of a micromirror array of a projection apparatus disclosed in a prior art patent.

FIG. 1C is a circuit diagram showing the configuration of a drive circuit of mirror elements of a projection apparatus disclosed in a prior art patent.

FIG. 1D shows the scheme of Binary Pulse Width Modulation (Binary PWM) of conventional digital micromirrors for generating a grayscale.

FIG. 2 is a functional block diagram showing an exemplary configuration of a display system according to a preferred embodiment of the present invention.

FIG. 3 is a diagram showing an exemplary configuration of a spatial light modulation element constituting a display system according to a preferred embodiment of the present invention.

FIG. 4 is a functional diagram showing the configuration of an individual pixel unit constituting a spatial light modulator according to a preferred embodiment of the present invention.

FIG. 5 is a top view for showing a diagonal perspective view of a mirror device comprised of, in two dimensions on a device substrate, a plurality of mirror elements, each controlling the reflecting direction of an incident light by the deflection a mirror.

FIG. 5A is a table showing an exemplary specification of the structure of a spatial light modulation element constituting a display system according to a preferred embodiment of the present invention.

FIG. 6 is a timing diagram showing an exemplary mirror control profile used in a display system according to a preferred embodiment of the present invention.

FIG. 7A is a cross-sectional diagram showing the ON state of a micromirror.

FIG. 7B is a timing diagram showing the intensity of light projected in the ON state of a micromirror.

FIG. 7C is a cross-sectional diagram showing the OFF state of a micromirror.

FIG. 7D is a timing diagram showing the intensity of light projected in the OFF state of a micromirror.

FIG. 7E is a cross-sectional diagram showing the oscillating state of a micromirror.

FIG. 7F is a timing diagram showing the intensity of light projected in the oscillating state of a micromirror.

FIG. 8A is a cross-sectional diagram exemplifying the specific configuration of a pixel unit in a display system according to a preferred embodiment of the present invention;

FIG. 8B is a top view diagram of the pixel unit in a display system shown in FIG. 8A;

FIG. 8C is a top view diagram of FIG. 8A, with the mirror removed from the pixel unit;

FIG. 8D is a cross-sectional diagram of the mirror element shown in FIG. 8A when it is deflected in an ON state;

FIG. 8E is a cross-sectional diagram of the mirror element shown in FIG. 8A when it is deflected in an OFF state;

FIG. 9A is a functional diagram showing the action of a pixel unit of the configuration exemplified in FIGS. 8A through 8E;

FIG. 9B is a functional diagram showing the action of a pixel unit of the configuration exemplified in FIGS. 8A through 8E;

FIG. 9C is a functional diagram showing the action of a pixel unit of the configuration exemplified in FIGS. 8A through 8E;

FIG. 9D is a functional diagram showing the action of a pixel unit of the configuration exemplified in FIGS. 8A through 8E;

FIG. 10A is a functional circuit diagram showing an exemplary configuration of a pixel unit comprised in a display system, according to a preferred embodiment of the present invention;

FIG. 10B is a functional circuit diagram showing an exemplary modification of a pixel unit comprised in a display system, according to a preferred embodiment of the present invention;

FIG. 10C is a top view diagram showing the layout of a capacitor used in an exemplary modification of a pixel unit comprised in a display system, according to a preferred embodiment of the present invention;

FIG. 10D is a functional circuit diagram showing another exemplary modification of a pixel unit comprised in a display system, according to a preferred embodiment of the present invention;

FIG. 10E is a functional circuit diagram showing an exemplary modification of a pixel array comprised in a display system according to a preferred embodiment of the present invention;

FIG. 11A is a functional diagram showing the action of a pixel unit comprised in a display system, according to a preferred embodiment of the present invention;

FIG. 11B is a functional diagram showing the action of a pixel unit comprised in a display system, according to a preferred embodiment of the present invention;

FIG. 11C is a functional diagram showing the action of a pixel unit comprised in a display system, according to a preferred embodiment of the present invention;

FIG. 11D is a functional diagram showing the equalization circuit shown in FIG. 11B;

FIG. 11E is a functional diagram showing the equalization circuit shown in FIG. 11C;

FIG. 12A is a functional circuit diagram exemplifying the placement of the peripheral circuit of a pixel array comprised in a display system, according to a preferred embodiment of the present invention;

FIG. 12B is a functional diagram exemplifying the internal configuration of a plate line driver (PL Driver) exemplified in FIG. 12A;

FIG. 12C is a functional diagram exemplifying the internal configuration of a plate line address decoder (PL Address Decoder-a) exemplified in FIG. 12A;

FIG. 12D is a functional diagram showing an exemplary modification configured by adding a function to the plate line address decoder (PL Address Decoder-a) exemplified in FIG. 12C;

FIG. 12E is a diagram exemplifying the internal configuration of a bit line driver unit (Bitline Driver) exemplified in FIG. 12A;

FIG. 12F is a table showing the regulation of the operation of the bit line driver unit (Bitline Driver) exemplified in FIG. 12E;

FIG. 13 is a timing diagram exemplifying the operation of a pixel array of the configuration exemplified in FIG. 10A;

FIG. 14 is a timing diagram of the address decoder for the ROW lines exemplified in FIG. 12A;

FIG. 15 is a functional circuit diagram showing another exemplary modification of the pixel unit exemplified in FIG. 10A;

FIG. 15A is a cross-sectional diagram of a pixel unit in an ON state, comprising two electrodes, i.e., an ON electrode and a second ON electrode, exemplified in FIG. 15;

FIG. 15B is a cross-sectional diagram of a pixel unit in an OFF state, comprising two electrodes, i.e., an ON electrode and a second ON electrode exemplified in FIG. 15;

FIG. 15C is an illustrative top view diagram showing an exemplary layout of the second ON electrode that is added to the pixel unit exemplified in FIG. 15;

FIG. 15D is an illustrative top view diagram showing another exemplary layout of the second ON electrode that is added to the pixel unit exemplified in FIG. 15;

FIG. 15E is a top view diagram showing another exemplary layout of the second ON electrode that is added to the pixel unit exemplified in FIG. 15;

FIG. 15F is a cross-sectional diagram showing another exemplary layout of the second ON electrode that is added to the pixel unit exemplified in FIG. 15;

FIG. 15G is a functional circuit diagram showing an exemplary modification of the memory cell on the ON side of the pixel unit exemplified in FIG. 15;

FIG. 15H is a functional circuit diagram showing an exemplary modification of the connecting relationships among the memory cell on the ON side, a word line, and a plate line at the pixel unit exemplified in FIG. 15;

FIG. 16 is a timing chart showing the action of the pixel unit exemplified in FIG. 15;

FIG. 17A is a chart exemplifying the setup of a mirror control profile;

FIG. 17B is a chart exemplifying the setup of a mirror control profile;

FIG. 17C is a chart exemplifying the setup of a mirror control profile;

FIG. 17D is a chart exemplifying the setup of a mirror control profile;

FIG. 17E is a chart exemplifying the setup of a mirror control profile;

FIG. 17F is a chart exemplifying the setup of a mirror control profile;

FIG. 17G is a chart exemplifying the setup of a mirror control profile;

FIG. 18 is a functional circuit diagram showing another exemplary modification of the pixel unit exemplified in FIG. 10A;

FIG. 19 is a timing chart showing the action of another exemplary modification of the pixel unit exemplified in FIG. 18;

FIG. 20 is a functional circuit diagram to illustrate the layout of a peripheral circuit attaining the action of the timing chart in FIG. 19, which shows the action of the pixel unit exemplified in FIG. 18;

FIG. 21 is a functional circuit diagram showing another exemplary modification of the pixel unit exemplified in FIG. 10A;

FIG. 22A is a functional circuit diagram showing an exemplary modification of the configuration of placing the peripheral circuit for a pixel array according to a preferred embodiment of the present invention;

FIG. 22B is a functional circuit diagram showing an exemplary modification of the configuration of placing the peripheral circuit for a pixel array according to a preferred embodiment of the present invention;

FIG. 22C is a functional circuit diagram showing an exemplary modification of the configuration of placing the peripheral circuit for a pixel array according to a preferred embodiment of the present invention;

FIG. 22D is a functional circuit diagram showing an exemplary modification of the configuration of placing the peripheral circuit for a pixel array according to a preferred embodiment of the present invention;

FIG. 23A is a cross-sectional diagram showing an exemplary modification of the configuration of a pixel unit (i.e., a mirror element), comprising a mirror that is structured as a cantilever, according to a preferred embodiment of the present invention;

FIG. 23B is a functional diagram showing an exemplary configuration of the drive circuit used for FIG. 23A;

FIG. 24A is a functional circuit diagram exemplifying a part of the layout of the pixel unit comprising a mirror (shown in FIG. 23A) that is structured as a cantilever;

FIG. 24 B is a functional circuit diagram showing an exemplary modification of the circuit of the pixel array comprising a mirror (exemplified in FIG. 24A) that is structured as a cantilever;

FIG. 24C is a functional circuit diagram showing an exemplary modification of the circuit of the pixel array comprising a mirror (exemplified in FIG. 24A) that is structured as a cantilever;

FIG. 25A is a timing chart showing the action of a pixel unit (i.e., a mirror element) comprising a mirror (shown in FIG. 23A) that is structured as a cantilever;

FIG. 25B is a timing chart showing the action of the pixel unit (i.e., a mirror element), as shown in FIG. 23A structured as a cantilever;

FIG. 25C is a timing chart showing the action of the pixel unit (i.e., a mirror element), exemplified in FIG. 23A structured as a cantilever;

FIG. 26A is a top view diagram exemplifying the packaging structure of a package accommodating a spatial light modulator according to a preferred embodiment of the present invention;

FIG. 26B is a cross-sectional diagram of FIG. 26A;

FIG. 27 is a functional block diagram showing the configuration of a projection apparatus according to a preferred embodiment of the present invention;

FIG. 28 is a functional block diagram exemplifying the configuration of a control unit comprised in the projection apparatus exemplified in FIG. 27;

FIG. 29 is a functional block diagram showing another exemplary modification of a multi-panel projection apparatus according to a preferred embodiment of the present invention;

FIG. 30 is a functional block diagram showing an exemplary configuration of the control unit of a multi-panel projection apparatus according to a preferred embodiment of the present invention;

FIG. 31 is a functional diagram showing an exemplary modification of a multi-panel projection apparatus according to another preferred embodiment of the present invention;

FIG. 32 is a functional block diagram showing an exemplary configuration of a control unit comprised in the projection apparatus exemplified in FIG. 31; and

FIG. 33 is a chart showing the waveform of a control signal of the projection apparatus exemplified in FIG. 31.

### DESCRIPTION OF THE PREFERRED EMBODIMENTS

The following is a description, in detail, of the preferred embodiment of the present invention with reference to the accompanying drawings.

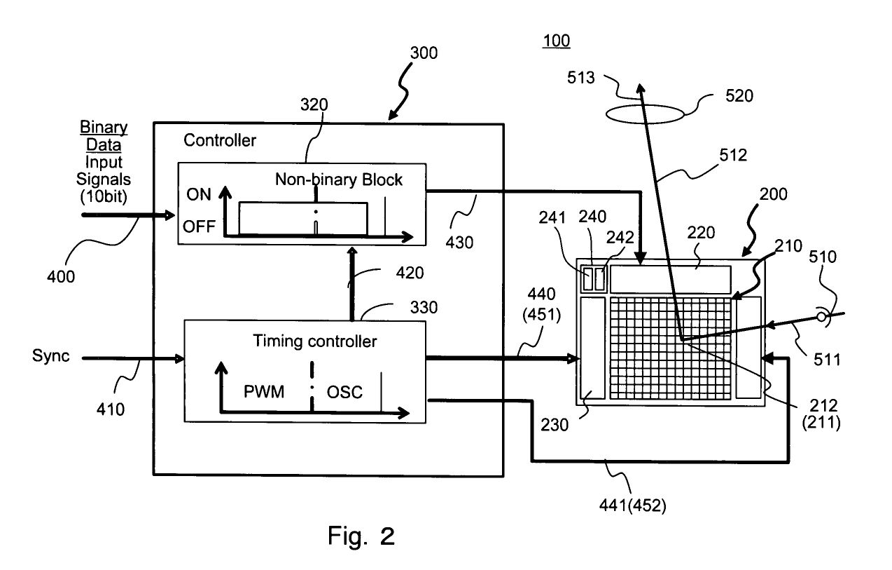

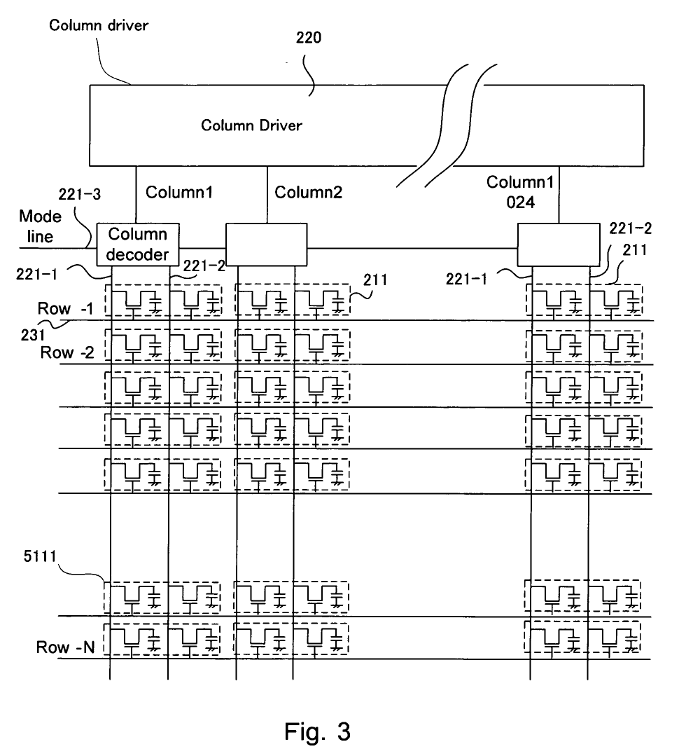

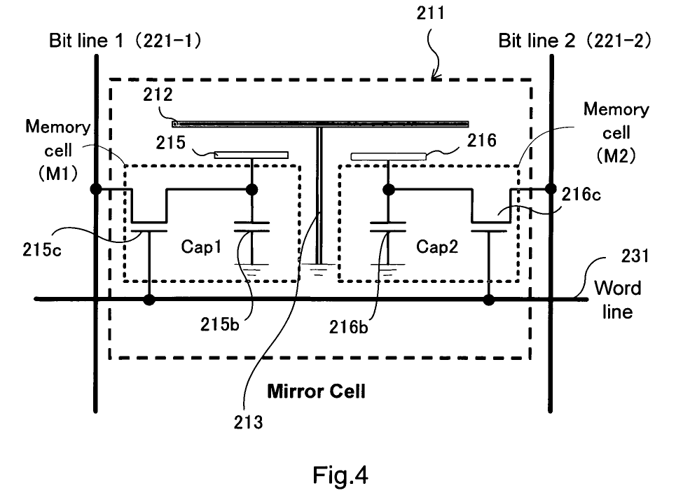

FIG. 2 is a functional block diagram showing an exemplary configuration of a display system according to a preferred embodiment of the present invention. FIG. 3 is a block diagram showing an exemplary configuration of a spatial light modulation element implemented in a display system according to a preferred embodiment of the present invention. FIG. 4 is a functional circuit diagram showing an exemplary configuration of a pixel unit 211 implemented in a spatial light modulator according to the present embodiment.

The projection apparatus 100 according to the present embodiment comprises a spatial light modulator 200, a control apparatus 300, a light source 510 and a projection optical system 520.

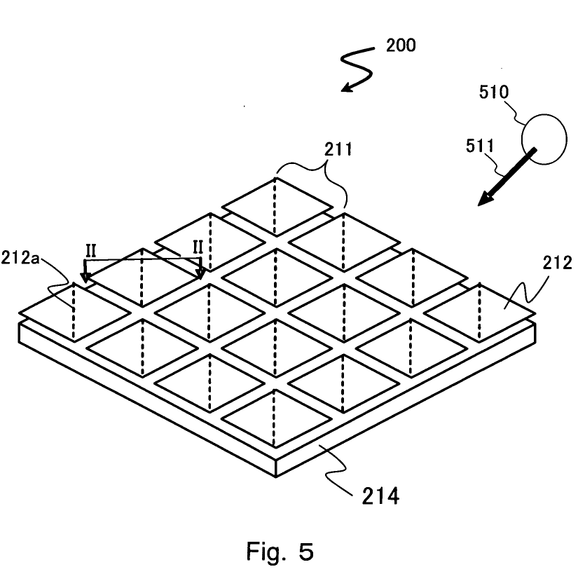

FIG. 5 is a top view diagram showing a diagonal perspective of a spatial light modulator in which multiple mirror elements (i.e., pixel units), which control the reflecting direction of incident light by the deflection of the mirrors, are arrayed in two dimensions on a device substrate.

As shown in FIG. 5, the spatial light modulator 200 is configured by arraying pixel units 211, each of which comprises an address electrode (not shown in the drawing), an elastic hinge (not shown in the drawing), and a square mirror 212 supported by the elastic hinge, in a two-dimensional array on a substrate 214.

The mirror 212 of one pixel unit 211 is controlled by applying a voltage to an address electrode placed on the substrate 214.

Meanwhile, the pitch (i.e., the interval) between adjacent mirrors 212 is preferably set anywhere between 4 μm and 14 μm, or more preferably between 5 μm and 10 μm, in consideration of the number of pixels ranging from a super high definition television (i.e., a full HD TV) (e.g., 2048 by 4096 pixels) to a non-full HD TV, and of the sizes of mirror devices. Specifically, the pitch is defined as the distance between the deflection axes of adjacent mirrors 212.

Specifically, the area size of a mirror 212 may be anywhere between 16 square micrometers (μm²) and 196 μm², more preferably anywhere between 25 μm² and 100 μm².

Note that the form of the mirror 212 or the pitch between the adjacent mirrors is arbitrary.

In FIG. 5, the dotted line shows the deflection axis 212a for deflecting the mirror 212. An incident light 511 emitted from a coherent light source 510 is incident along a perpendicular or diagonal direction relative to the deflection axis 212a of the mirror 212. The light source 510 may be implemented with a laser light source to emit a coherent light.

The following provides a description of the comprisal and operation of one pixel unit 211 with reference to the cross-sectional diagram thereof on the line II-II of the spatial light modulator 200 shown in FIG. 5.

FIG. 4 is an outline diagram of a cross-section, viewed as indicated by the line II-II in FIG. 5, of one mirror element of the spatial light modulator.

As shown in FIGS. 3 and 4, the spatial light modulator 200 according to the present embodiment comprises the pixel array 210, bit line driver unit 220 and word line driver unit 230.

In the pixel array 210, pixel units 211 are positioned in a grid where individual bit lines 221 extending vertically from the bit line driver unit 220 cross individual word lines 231 extending horizontally from the word line driver unit 230.

As shown in FIG. 4, each pixel unit 211 comprises a mirror 212 which tilts freely while supported on the substrate 214 by a hinge 213.

An OFF electrode 215 (and an OFF stopper 215a) and the ON electrode 216 (and an ON stopper 216a) are positioned symmetrically across the hinge 213 that comprises a hinge electrode 213a on the substrate 214.

When a predetermined voltage is applied to the OFF electrode 215, it attracts the mirror 212 with a Coulomb force and tilts the mirror 212 so that it abuts the OFF stopper 215a. This causes the incident light 511 to be reflected to the light path of an OFF position, which is not aligned with the optical axis of the projection optical system 130.

When a predetermined voltage is applied to the ON electrode 216, it attracts the mirror 212 with a Coulomb force and tilts the mirror 212 so that it abuts the ON stopper 216a. This causes the incident light 311 to be reflected to the light path of an ON position, which is aligned with the optical axis of the projection optical system 130.

An OFF capacitor 215b is connected to the OFF electrode 215 and to the bit line 221-1 by way of a gate transistor 215c that is constituted by a field effect transistor (FET) and the like.

Further, an ON capacitor 216b is connected to the ON electrode 216, and to the bit line 221-2 by way of a gate transistor 216c, which is constituted by a field effect transistor (FET) and the like. The opening and closing of the gate transistor 215c and gate transistor 216c are controlled with the word line 231.

Specifically, one horizontal row of pixel units 211 that are lined up with an arbitrary word line 231 are simultaneously selected, and the charging and discharging of capacitance to and from the OFF capacitor 215b and ON capacitor 216b are controlled by way of the bit lines 221-1 and 221-2, and thereby the individual ON/OFF controls of the micromirrors 212 of the respective pixel units 211 of one horizontal row are carried out.

In other words, the OFF capacitor 215b and gate transistor 215c on the side of the OFF electrode 215 constitute a memory cell M1 that is a so called DRAM structure.

Likewise, the ON capacitor 216b and gate transistor 216c on the side of the ON electrode 216 constitute a DRAM-structured memory cell M2.

With this configuration, the tilting operation of the mirror 212 is controlled in accordance with the presence and absence of writing data to the respective memory cells of the OFF electrode 215 and ON electrode 216.

As shown in FIG. 2, the light source 510 illuminates the spatial light modulator 200 with the incident light 511, which is reflected by the individual micromirrors 212 as a reflection light 512. The reflection light 512 then passes through a projection optical system 520 and is projected, as projection light 513.

A control apparatus 300, according to the present embodiment, controlling the spatial light modulator 200 uses the ON/OFF states (i.e., an ON/OFF modulation) and oscillating state (i.e., an oscillation modulation) of the mirror 212, thereby attaining an intermediate gray scale.

A non-binary block 320 generates non-binary data 430 used for controlling the mirror 212 by converting an externally inputted binary video signal 400 into non-binary data. In this event, one LSB is different between the period of ON/OFF states of the mirror 212 and the period of intermediate oscillating state.

A timing control unit 330 generates, on the basis of an input synchronous signal 410 (Sync), a drive timing 420 for the non-binary block 320, a PWM drive timing 440, and an OSC drive timing 441 for the mirror 212.

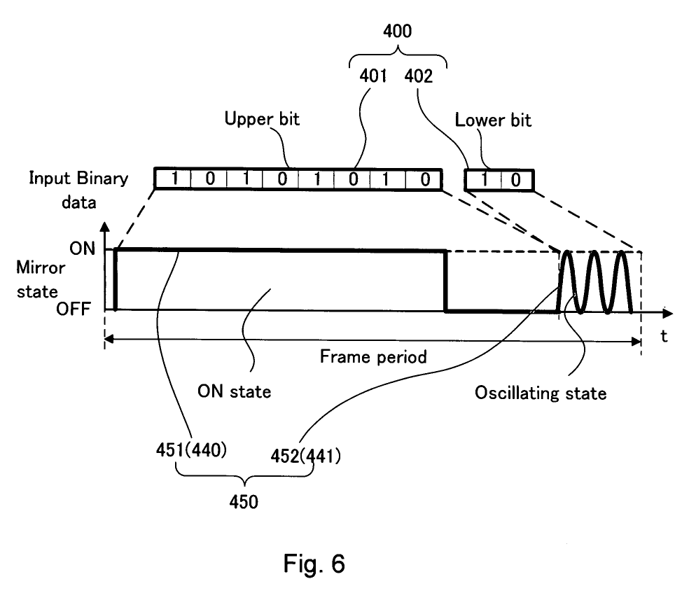

As shown in FIG. 6, the present embodiment is configured such that a desired number of bits of the upper bits 401 of the binary video image signal 400 is assigned to the ON/OFF control for the mirror and the remaining lower number of bits 402 is assigned to the oscillation control. Then, the control is such that the ON/OFF (positioning) state is controlled by the PWM drive timing 440 from the timing control unit 330 and the non-binary data 430, while the oscillation state is controlled by the PWM drive timing 440 and OSC drive timing 441 from the timing control unit 330 and the non-binary data 430.

The next is a description of the basic control of the micromirror 212 of the spatial light modulator 200 according to the present embodiment.

Note that “Va (1, 0)” indicates an application of a predetermined voltage Va to the OFF electrode 215 and no application of voltage to the ON electrode 216 in the following description.

Similarly, “Va (0, 1)” indicates no application of voltage to the OFF electrode 215 and an application of a voltage Va to the ON electrode 216.

“Va (0, 0)” indicates no application of voltage to either the OFF electrode 215 or ON electrode 216.

“Va (1, 1) indicates the application of a voltage Va to both the OFF electrode 215 and ON electrode 216.

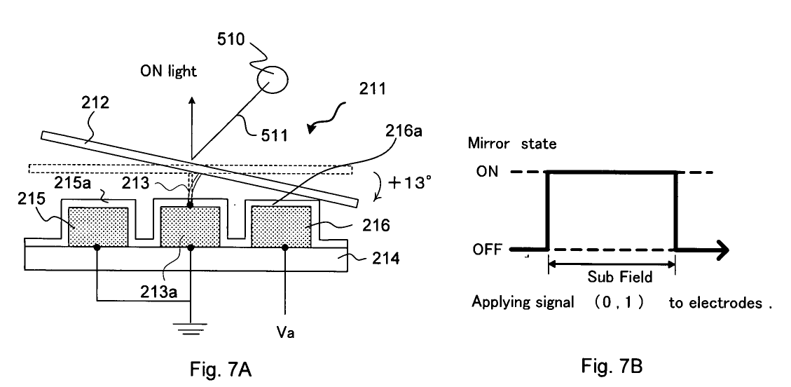

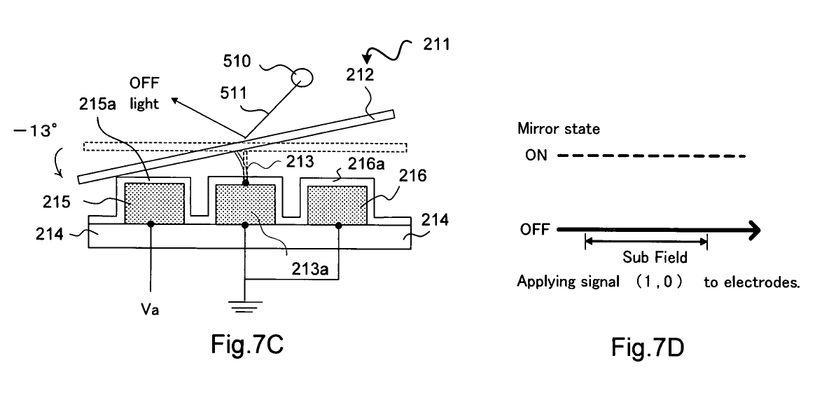

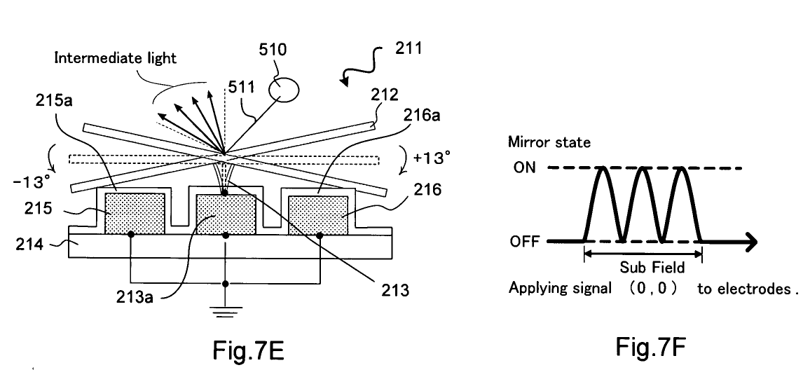

FIGS. 7A, 7B, 7C, 7D, 7E and 7F show the configuration of the pixel unit 211 comprising the mirror 212, hinge 213, OFF electrode 215 and ON electrode 216, and a basic example in which the mirror 212 is controlled under an ON/OFF state and under an oscillating state

FIG. 7A shows the mirror 212 tilted from the neutral state to the ON state by being attracted to the ON electrode 216 as a result of applying a predetermined voltage (i.e., Va (0, 1)) to only the ON electrode 216. In the ON state of the mirror 212, the reflection light 512, by way of the mirror 212, is captured by the projection optical system 520 and projected as a projection light 513. FIG. 7B shows the intensity of light projected in the ON state.

FIG. 7C shows the mirror 212 tilted from the neutral state to the OFF state by being attracted to the OFF electrode 215 as a result of applying a predetermined voltage (i.e., Va (1, 0)) to only the OFF electrode 215. In the OFF state of the mirror 212, the reflection light 512 is deflected from the projection optical system 520, and therefore does not constitute a projection light 513. The far right side of FIG. 7B shows the intensity of light projected in the OFF state.

FIG. 7D shows the intensity of light projected in the OFF state.

FIG. 7E exemplifies a case of the mirror 212 performing a free oscillation in the maximum amplitude of A0 between a tilted position (i.e., a Full ON) in contact with the ON electrode 216 and another tilted position (i.e., a Full OFF) in contact with the OFF electrode 215 (at Va (0, 0)).

An incident light 511 is illuminated on the mirror 212 at a prescribed angle, and the intensity of light resulting from the incident light 511 reflecting in the ON direction and a portion of the light (i.e. the intensity of light of the reflection light 512) reflecting in a direction that is between the ON direction and OFF direction are incident to the projection optical system 520 so as to be projected as projection light 513. FIG. 7F shows the intensity of light projected in an oscillating state.

That is, in the ON state of the mirror 212 shown in FIG. 7A, the flux of light of the reflected reflection light 512 is directed in the ON direction so as to be captured almost entirely by the projection optical system 520 and projected as the projection light 513.

In the OFF state of the mirror 212 shown in FIG. 7C, the reflection light 512 is directed in an OFF direction away from the projection optical system 520, and thus a light projected as a projection light 513 does not exist.

In the oscillating state of the micromirror 212 shown in FIG. 7E, a portion of the light flux of the reflection light 512, diffraction light, diffusion light and the like are captured by the projection optical system 520 and projected as a projection light 513.

Note that the examples shown in FIGS. 7A, 7B, 7C, 7D, 7E and 7F described above have been described for a case of applying the voltage Va represented by a binary value of “0” or “1” to each of the OFF electrode 215 and ON electrode 216. Alternatively, a more minute control of the tilting angle of the mirror 212 is available by increasing the steps of the magnitude of Coulomb force generated between the mirror 212 and the OFF electrode 215 or ON electrode 216 by increasing the steps of the voltage values Va to multiple values.

Also note that the examples shown in FIGS. 7A, 7B, 7C, 7D, 7E and 7F described above have been described for a case of setting the mirror 212 (i.e., the hinge electrode 213a) at the ground potential. Alternatively, a more minute control of the tilting angle of the mirror 212 may also be achieved by applying an offset voltage thereto.

The present embodiment is configured to apply the voltages, i.e., Va (0, 1), Va (1, 0) and Va (0, 0), at appropriate timings in the midst of the tilting of the mirror 212 between the ON and OFF states so as to generate a free oscillation in an amplitude that is smaller than the maximum amplitude between the ON and OFF states, thereby accomplishing a more minute gray scale.

The following shows a method for displaying a video image using the projection apparatus 100 according to the present embodiment shown in the above described FIG. 2.

Non-binary data 430, a PWM drive timing 440 and an OSC drive timing 441 are generated when a binary video signal 400 and a synchronous signal 410 are inputted into the control apparatus 300.

The non-binary block 320 and timing control unit 330 calculate, for each mirror of the SLM constituting a pixel of the video image of a frame, the period of time for controlling each mirror 212 under an ON state and under an oscillating state or the number of oscillations within one frame of a video image, in accordance with the binary video signal 400 and the drive timing 420 generated by the timing control unit 330 from the synchronous signal 410. The non-binary block 320 and timing control unit 330 also generate non-binary data 430, a PWM drive timing 440 and an OSC drive timing 441.

Specifically, the non-binary block 320 and timing control unit 330 that are comprised in the control apparatus 300 use the ratio of the intensity of a projection light 513 obtained by oscillating a predetermined mirror 212 in an oscillation time T to the intensity of a projection light 513 obtained by controlling the mirror 212 under an ON state during the oscillation time T, and calculate the period of time for controlling the mirror 212 under an ON state, the period of time for controlling the mirror 212 under the oscillating state or the number of oscillations during the period.

The non-binary block 320 and timing control unit 330 carry out the ON/OFF control and oscillation control for each of the mirrors 212 constituting one frame of video image using non-binary data 430, PWM drive timing 440 and OSC drive timing 441, all of which are generated on the basis of the calculated value of the time or the number of times of oscillation.

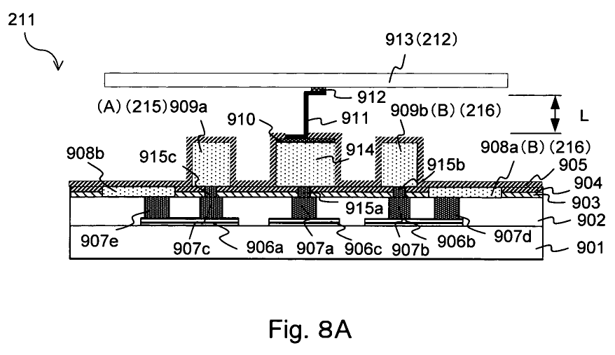

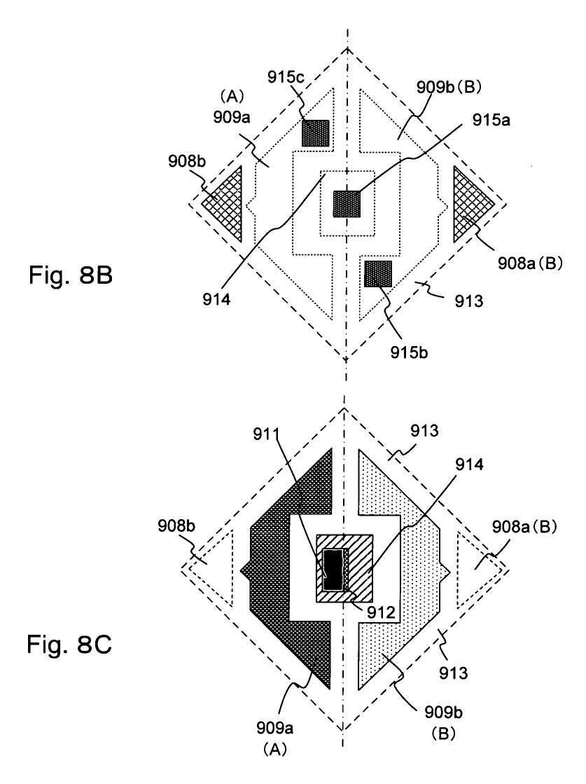

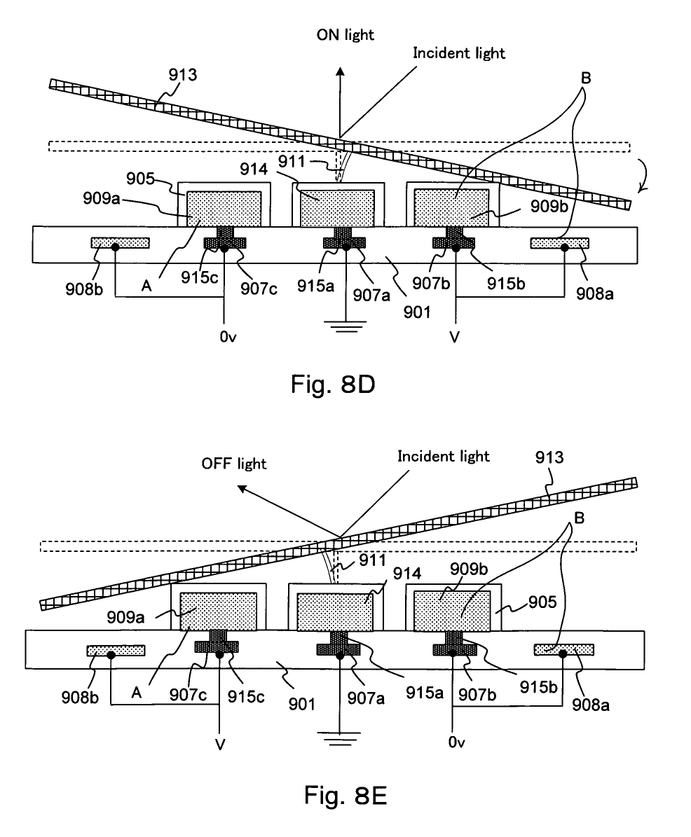

FIG. 8A is a cross-sectional diagram exemplifying the specific configuration of a pixel unit 211 in the above described spatial light modulator 200.

The mirror element shown in FIG. 8A comprises wirings 906a, 906b, and 906c of a drive circuit used for driving and controlling a mirror 913; first Vias 907a, 907b, 907c, 907d, 907d, and 907e, all of which are connected to the wirings 906a, 906b, and 906c of the drive circuit; and a first insulation layer 902. All of the components described above are formed on a substrate 901. The wiring 906a, on the left side of the diagram, is equipped with two first Vias 907a and 907e, with the first insulation layer 902 separating the two Vias. Likewise, the wiring 906b, on the right side of the diagram, is equipped with two first Vias 907b and 907d, with the first insulation layer 902 separating the two Vias. The wiring 906c, in the center of the diagram, is equipped with only one first Via 907a. In summary, the present embodiment equips five first Vias in the insulation layer 902.

The present embodiment is configured with the wirings on the left and right sides each has opening functioning as two first via-connectors. Alternately, however, the number of first vis-connectors may be different between the left and right sides. Further, the number of first Vias may vary from the description of the present embodiment.

Further, second Vias 915a, 915b and 915c and surface electrodes 908a and 908b, are formed on the first Vias 907a, 907b, 907c, 907d, 907d and 907e, respectively.

The second Via 915a is formed on the first Via 907a in the center of the diagram, while the second Vias 915b and 915c are respectively formed on the first Vias 907b and 907c, on the right and left sides of the diagram, respectively. Surface electrodes 908a and 908b are respectively formed on the remaining first Vias 907d and 907e.

Further, a first protective layer 903 is deposited on the first insulation layer 902, and a second protective layer 904 is further formed on the first protective layer 903.

The substrate 901 is preferred to be a silicon substrate.

The wirings 906a, 906b and 906c of the drive circuit are preferably aluminum wirings.

The first Vias 907a, 907b, 907c, 907d, 907d and 907e and the second Vias 915a, 915b and 915c are preferably made of a metallic material containing tungsten and/or copper.

The surface electrodes 908a and 908b may be made of a material (e.g., tungsten) similar to that of the first Vias and second Vias, or of a material with high electrical conductivity, such as aluminum. The form of the surface electrodes 908a and 908b is arbitrary. Further, FIG. 8A exemplifies the case of forming the surface electrodes 908a and 908b on the first Vias 907d and 907e, respectively; they may alternatively be formed directly on the wirings 906a and 906b.

The first insulation layer 902, first protective layer 903, and second protective layer 904 are preferably layers containing silicon, such as silicon carbide (SiC), amorphous silicon, and silicon dioxide (SiO₂).

If aluminum is used for the surface electrodes 908a and 908b, direct contact between the amorphous silicon and aluminum electrode corrodes the aluminum, and therefore, a silicon carbide (SiC) layer between the amorphous silicon and aluminum surface electrodes 908a and 908b is recommended. Alternatively, an electrode may be formed by mixing aluminum with an impurity, such as silicon, or a barrier layer may be provided by using a material other than an SiC layer. Such a barrier layer may comprise two or more layers.

As an example, the first insulation layer 902 of FIG. 8A is one layer made of silicon carbide (SiC). The first insulation layer 902 may be made of another material such as titanium nitride (TiN), or the like, in consideration of the etchant used on the sacrificial layer during the production process, or to prevent the stiction of a mirror element to the electrode 909a or 909b when the former deflects and abuts on the latter.

The mirror element according to the present embodiment is configured to equip the electrodes 909a, 909b and 914 so as to secure electrical connection to the second Vias 915a, 915b and 915c, respectively. The electrodes 909a, 909b and 914 is preferably comprised of a material with high electrical conductivity, such as aluminum.

The electrode 914, shown in the center of FIG. 8A, is an electrode equipped for an elastic hinge 911 and is configured to be the same height as the electrodes 909a and 909b on the left and right. When the individual electrodes 909a, 909b and 914 are formed to be the same height, it is possible to form the three electrodes 909a, 909b and 914 in the same production process. Further, a barrier layer 910 made of tantrum, titanium, or such is formed on the electrode 914 at the center. The barrier layer 910 may be composed of two or more layers.

Further, by modifying the height of the electrode at the center, it is possible to determine the height of the elastic hinge 911. The height of the elastic hinge 911 may also be determined by adjusting the height of the barrier layer 910.

Then, the elastic hinge 911 is formed on the electrode 914 at the center, on which the barrier layer 910 has also been formed, so as to be connected to the barrier layer 910.

The elastic hinge 911 is made of, for example, amorphous silicon. The thickness of the elastic hinge 911 (in the horizontal direction of FIG. 8A) is preferably between approximately 150 and 400 angstroms.

Alternately, a plurality of elastic hinges may be provided for one mirror, and the mirror may be supported thinner elastic hinges. For example, two elastic hinges, which are narrower than the conventional configuration, may be placed at both ends of the mirror.

The elastic hinge 911 is preferably applied with In-Situ doping (such as arsenic and phosphorus), an ion implanting, a diffusion of metallic silicide, such as nickel silicide (NiSi), titanium silicide (TiSi), so as to possess electrical conductivity.

Furthermore, the present embodiment is configured to deposit a second insulation layer 905 on the surface of the region of the substrate on which the electrodes 909a, 909b and 914 have been formed.

The second insulation layer 905 is preferably a layer containing silicon such as silicon carbide (SiC), amorphous silicon and silicon dioxide (SiO₂). This layer is formed to prevent corrosion by the etchant hydrogen fluoride (HF), in the case in which the electrodes 908a, 908b, 909a, 909b and 914 are made of aluminum, as described above.

Meanwhile, the upper surface of the elastic hinge 911 may be provided with a joinder layer, which can be configured to be the same form and area as the mirror 913. The present embodiment is configured so that the joinder layer is the smallest area size possible. Such a configuration makes it possible to prevent the mirror 913 from being deformed or warped by the difference in thermal expansion coefficients between the mirror 913 and joinder layer.

Further, a metallic layer 912 is deposited on the joinder layer of the elastic hinge 911 in order to secure electric conductivity between the elastic hinge 911 and mirror 913, while eliminating a variation in the heights among individual mirror elements. The metallic layer 912 is made of a material containing tungsten or titanium; alternately, a material containing another metal may be deposited.

If the mirror 913 is made of aluminum and the elastic hinge 911 is structured by using a silicon material, then a barrier layer (not shown in drawing) may further be layered on and under the metallic layer 912 in order to prevent the mirror 913 from coming in contact with the elastic hinge 911. Such a barrier layer may be constituted by two or more layers. The barrier layer is made of, for example, a material containing tantrum, titanium, et cetera.

Further, the mirror element according to the present embodiment is structured by forming a mirror 913 on the metallic layer 912 of the elastic hinge 911. The mirror 13 is desired to be made of a material with high reflectivity of light, such as aluminum.

The mirror 913 is preferred to be approximately square, with each side between 4.5 and 11 μm. The gap between individual mirrors 913 is preferably between 0.15 and 0.55 μm. Further, the aperture ratio of individual mirror element is preferably designed to be about 90%.

Such is the configuration of the mirror element according to the present embodiment shown in FIG. 8A.

FIG. 8B is a top view diagram of the surface of the substrate of the mirror device according to the present embodiment.

Note that the surface electrodes 909a and 909b, the hinge electrode 914, and the second Vias 915a, 915b and 915c are delineated by the dotted lines. The deflection axis of the mirror 913 is indicated by the vertical dashed line.

As shown in FIG. 8B, the second Vias 915a, 915b and 915c, which secure an electric conduction with the electrodes 909a, 909b and 914, are placed under the electrodes 909a, 909b and 914. The surface electrodes 908a and 908b, configured in a manner to increase the Coulomb force for deflecting the mirror 913, are formed under the mirror 913.

FIG. 8C is a top view diagram of the mirror element according to the present embodiment, in which the mirror 913 is removed.

As shown in FIG. 8C, the respective apexes of the electrodes 909a and 909b at both ends of the mirror 913 are formed as protrusions. Further, the design is such that the deflection angle of the mirror 913 is at a prescribed angle as a result of the mirror 913 hitting the protrusion of the electrodes 909a and 909b when the mirror 913 is deflected.

Note than the tips of the electrodes 909a and 909b are preferably designed so as to make the deflection angle of the mirror 913 anywhere between 12 and 14 degrees. Such a deflection angle of the mirror 913 is preferably designed in compliance with the design of the light source and optical system of a projection apparatus. Further, the length of the elastic hinge 911 of each mirror element is preferably configured to be no longer than 2 μm, and the mirror 913 is preferably configured to be an approximate square with the length of one side being 10 μm or smaller.

The equipping of the surface of the substrate with the electrodes 909a and 909b and hinge electrode 914 causes the substrate surface to possess convex and concave surfaces.

FIG. 8D is a cross-sectional diagram of the mirror element shown in FIG. 8A when it is deflected in an ON state.

In the present embodiment it is assumed that the light emitted from a light source is reflected as an ON light when the mirror 913 is deflected to the right side, and that the light emitted from the light source is reflected as an OFF light when the mirror 913 is deflected to the left side.

When a voltage is not applied to the individual surface electrode 908a or 908b or to the individual surface electrode 909a or 909b, the elastic hinge 911 is not deformed, and the mirror 913 is maintained in the horizontal direction.

When a voltage to the right surface electrode 909b and to the right surface electrode 908a is applied, the Coulomb force determined by the following expression is generated:

[top surface area size of electrode]*[voltage applied to electrode]*[the second power of the distance between aluminum and mirror]

The Coulomb force is generated between the right surface electrode 909b and mirror 913 and between the right surface electrode 908a and mirror 913, and the mirror 913 is deflected by the total Coulomb force generated.

In this configuration, the distance between the mirror 913 and right surface electrode 908a is greater than that between the mirror 913 and right surface electrode 909b, and the area of the right surface electrode 908a is smaller than that of the right surface electrode 909b, and therefore the generated Coulomb force is also smaller than that generated between the right surface electrode 909b and mirror 913.

When the mirror 913 is attracted to and deflected towards the right surface electrode 908a, the mirror 913 is deflected to an angle between 12 and 14 degrees, and the reactive force of the elastic hinge, due to the resilience, is strong. The Coulomb force attracts the corner of the mirror 913 to the right surface electrode 908a on the substrate surface in such a way that the mirror 913 can be attracted by a smaller Coulomb force because of the principle of lever (i.e., the principle of the moment of a rigid body). As a result, when a low voltage is applied, the right surface electrode 908a is capable of retaining the deflection of the mirror 913.

When the mirror 913 is deflected to the right side, the left surface electrode 908b and the left surface electrode 909a are at the same potential and are grounded by being connected to the ground.

FIG. 8E is a cross-sectional diagram of the mirror element shown in FIG. 8A deflected to an OFF state.

In FIG. 8E, the application of a voltage to the left surface electrode 909a and left surface electrode 908b makes it possible to deflect the mirror 913 to the left. The principles and the actions of the Coulomb force in this case are similar to those noted for FIG. 8D, and therefore the descriptions are not provided here.

Incidentally, if the shape of the mirror 913 and elastic hinge 911 are varied between the right and left sides of the mirror element, if the resilience of the elastic hinge 911 is differentiated between the right and left sides of the mirror element, and if the deflection control for the mirror 913 is changed between the right and left sides of the mirror element, then the area size, height and placement (i.e., layout) of the surface electrodes 908a and 908b or the surface electrodes 909a, 909b and 914 may be changed so as to apply an appropriate voltage to control the deflection of the mirror 913.

Alternately, the voltages may be applied in multiple steps to the surface electrodes 908a and 908b and surface electrodes 909a and 909b.

Furthermore, the circuits and voltages for driving the surface electrodes 908a or 908b and surface electrodes 909a or 909b may be appropriately changed. In other words, in this case, the surface electrodes 908a and 909b may be driven together, or the surface electrodes 908b and 909a may be driven together.

Further, both or either one of the surface electrodes 908a or 908b and surface electrodes 909a or 909b may protrude from the surface of the substrate.

Both or either one of the surface electrodes 908a or 908b and electrodes 909a or 909b may be placed on the surface of the substrate.

According to the process described above, the mirror 913 of the mirror element according to the present embodiment is deflected, and thereby the reflecting direction of the illumination light can appropriately be changed.

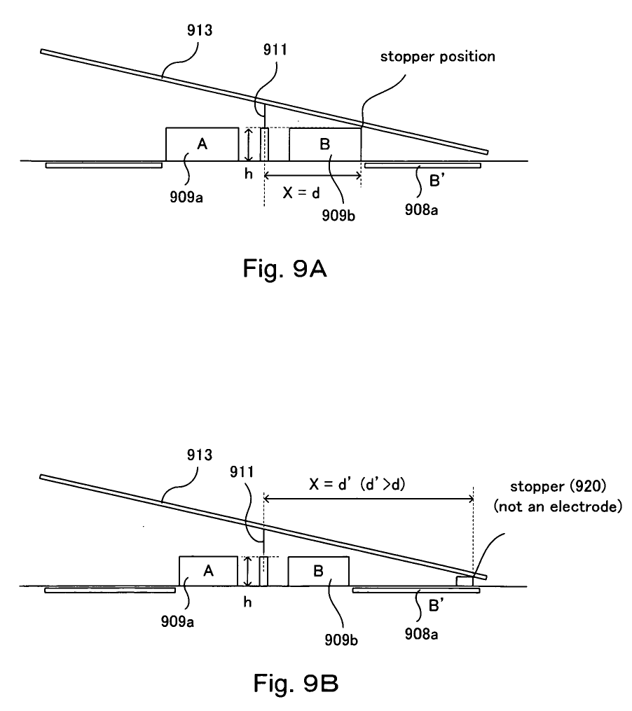

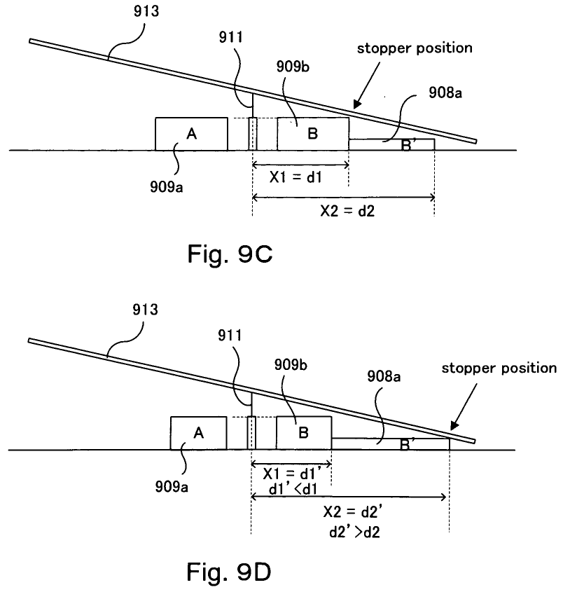

What follows is a description of the advantages of the configuration of the present embodiment of placing the surface electrode 909b and 909a on the ON side and the OFF side opposite from each other, with reference to FIGS. 9A, 9B, 9C and 9D.

FIG. 9A is a conceptual diagram which illustrates the advantage in the structure of the pixel unit 211, exemplified in the above described FIG. 8A, as a simplified version of FIG. 8A.

FIG. 9A shows the configuration of using the surface electrodes, 909a (electrode A) and 909b (electrode B), as stoppers. In this configuration, the electrodes A and B are placed on the substrate 901, while the electrode 908a (electrode B′) is buried under the surface of the substrate 901.

If the position of each stopper (i.e., the electrode A or B) is at a short distance (i.e., a distance d) from the elastic hinge 911, the accuracy of the deflection angle of the mirror 913, determined by h/d, where “h” is the height of the root of the elastic hinge 911, is slightly decreased. The heights of the electrodes A and B, however, may be fabricated with accurately controlled processes to have the same height h.

The position of each stopper (i.e., the electrode A or B) is close to the elastic hinge 911, and therefore, the spring force (i.e., the rigidity) of the elastic hinge 911 may be decreased in order to counter the stiction (i.e., an attraction force attributable to an intermolecular attraction) between the mirror 913 and stopper, which is an advantage when decreasing the size of the mirror element.

FIG. 9B exemplifies the case of placing a stopper farther from the elastic hinge 911 of the electrodes B and B′.

In this case, if the position of each stopper (i.e., the electrode A or B) is at a greater distance (i.e., a distance d′) from the elastic hinge 911, the accuracy of the deflection angle of the mirror 913 is increased.

In order to detach the mirror 913 from a stopper 920 with a spring force that is greater than the stiction between the mirror 913 and stopper 920, however, a stronger spring force is required than in the configuration shown in the above described FIG. 9A.

A stronger spring force of the elastic hinge 911 will, in turn, increase the voltage to be applied to the electrodes B and B′ for controlling the mirror 913.

FIGS. 9C and 9D exemplify the configuration of placing the electrodes B and B′ on the substrate 901.

Specifically, FIG. 9C exemplifies the case of causing the edge (at the distance d1 from the elastic hinge 911) of the electrode B to function as stopper, while FIG. 9D exemplifies the case of causing the electrode B′ to function as stopper.

In the example of FIG. 9C, the distance d2 of the edge of the electrode B′ from the elastic hinge 911 is configured to prevent the electrode B′ from coming in contact with the mirror 913.

In contrast, in the example of FIG. 9D, the distance d1′ of the edge of the electrode B from the elastic hinge 911 is set at a value smaller than the above described distance d1, and the distance d2′ of the edge of the electrode B′ from the elastic hinge 911 is set at a value larger than the above described distance d2, so that the edge of the electrode B′ functions as the stopper for the mirror 913.

In this configuration, the electrodes B and B′ are on the surface of the substrate 901, and therefore, the voltage to be applied to the electrodes B and B′ decreases, in comparison with the voltage described in FIGS. 9A and 9B, as the distance between the mirror 913 and the electrodes B/B′ decreases, when the area of the electrodes B and B′ is the same as the above described FIGS. 9A and 9B.

Further in FIGS. 9C and 9D, if the length of the elastic hinge 911 is the same, the configuration of FIG. 9C makes it possible to enlarge the area of the electrode B.

In contrast, the configuration shown in FIG. 9D makes it possible to enlarge the area of the electrode B′.

As described above, the separate placement of electrodes on the ON side, as exemplified by the electrode B (i.e., the surface electrode 909b) and electrode B′ (i.e., the surface electrode 908a) according to the present embodiment, optimizes the area of electrode, the distance between the mirror 913 and electrode B (and B′), and the distance of the electrodes B (and B′) from the elastic hinge 911, by using a plurality of electrodes B and B′, thereby making it possible to configure layout so as to minimize the drive voltage.

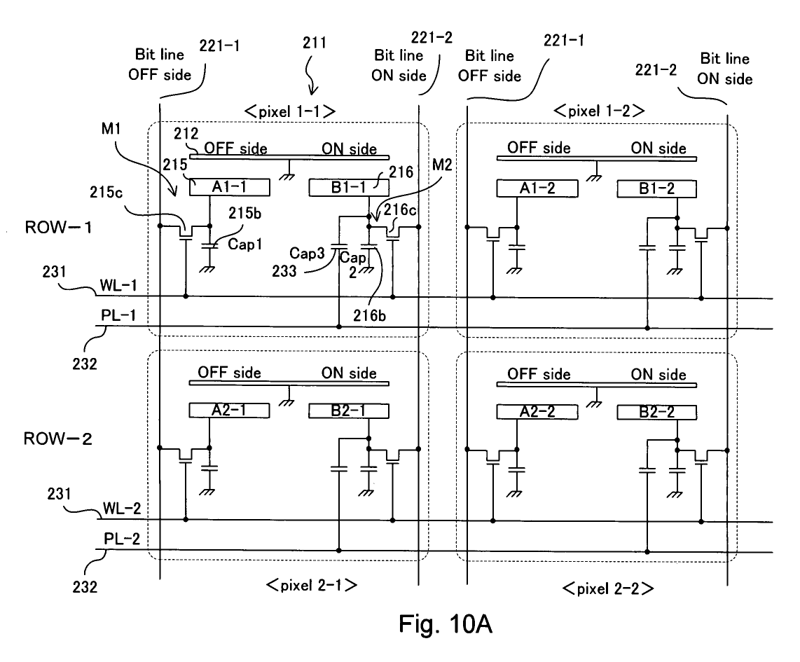

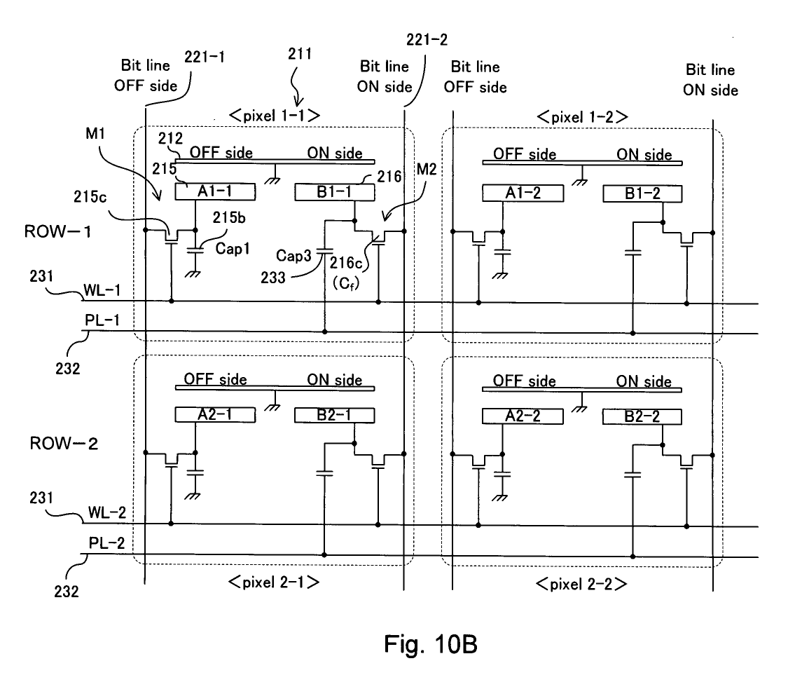

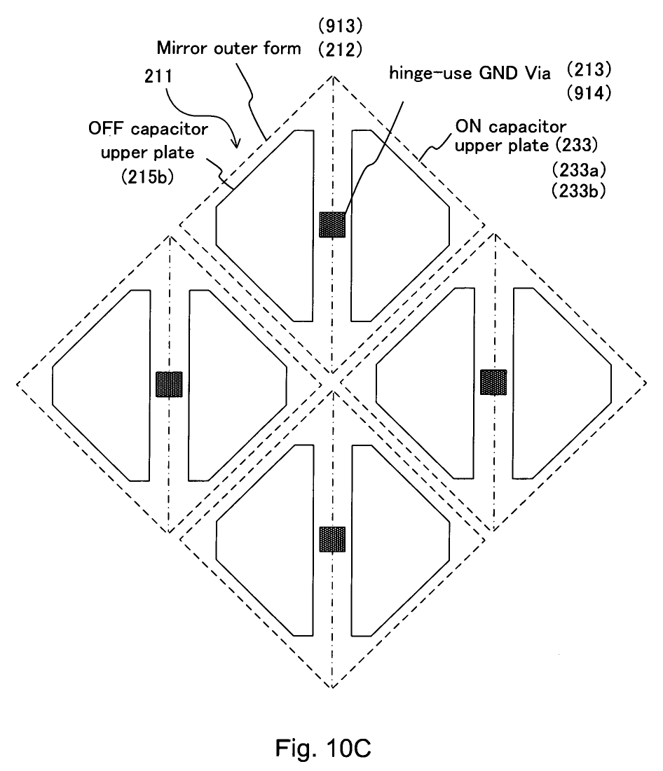

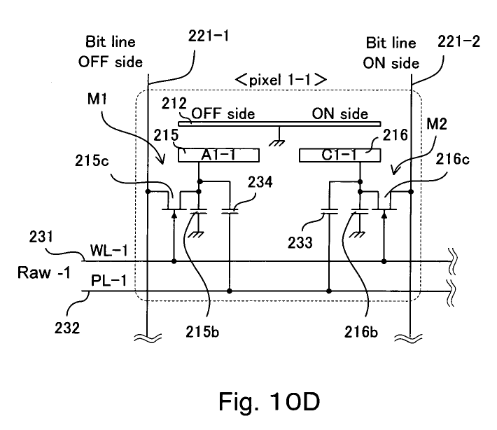

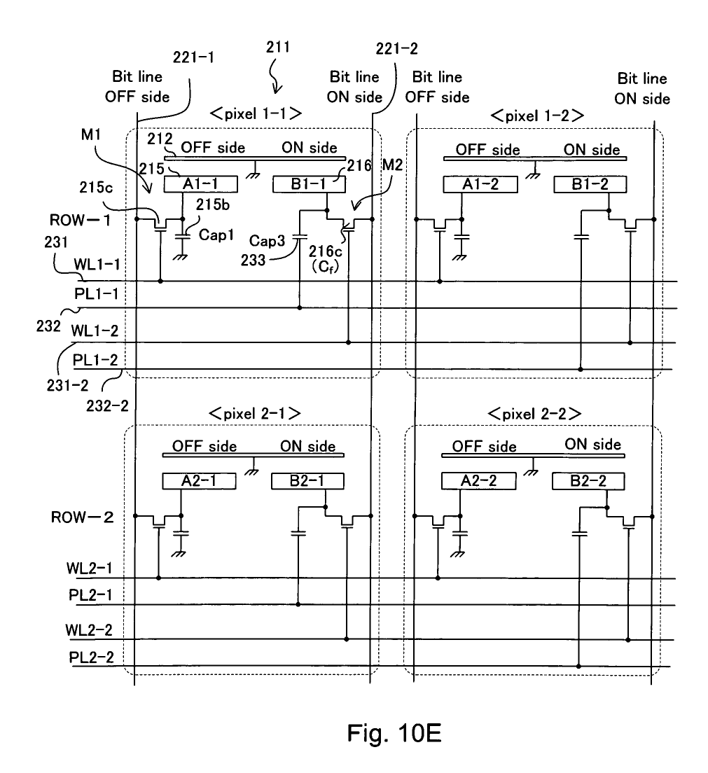

With the above described premising configuration in mind, what follows is a description of an exemplary configuration of a pixel unit 211 constituting the pixel array 210 of a spatial light modulator 200 according to the present embodiment, with reference to FIG. 10A.

In contrast to the configuration of the pixel unit 211 exemplified in FIG. 4, in which one pixel is equipped with one mirror, two electrodes, and two DRAM-structured memory cells, the present embodiment 1 is configured to add a plate lines 232 (PL-n; where “n” represents the number of ROW lines) to respective ROW lines and to interconnect the plate line 232 (PL) and ON electrode 216 by way of a second ON capacitor 233 (Cap 3).

This configuration enables the control of the ON electrodes 216 (i.e., B1-1, B1-2 and so on) of the same ROW line with lines other than Bitline (bit line 221-1 and bit line 221-2) and word line 231 (WL-1).

The present embodiment is configured such that the memory cell used for controlling the mirror 212 is a simple DRAM structure requiring only one transistor in the individual pixel unit 211 constituting the pixel array, and therefore, an increase in the size of the structure of the memory cell can be minimized, even if the plate line 232 and second ON capacitor 233 are added. Therefore, a high resolution image may be projected by arraying a larger number of pixel units 211 within a pixel array of a certain size.

Further, the addition of the plate line 232 and second ON capacitor 233 makes it possible to greatly expand the gray scale expression through a combination of the ON/OFF control and oscillation control of the mirror 212, as compared with a simple PWM control, as described later.

In other words, it is possible to attain both higher definition and higher level of gray scale for a projection image in the projection technique using a spatial light modulator, such as the spatial light modulator 200.

The following is a description of an example operation of the pixel unit 211 configured as shown in FIG. 10A.

On the word line 231 (WL) and plate line 232 (PL), both of which are placed on the same ROW line, the plate line 232 (PL) is activated when the word line 231 (WL) is not selected (L) and the ON electrode 216 is discharged (e.g., 0 volts).

With this, the ON electrode 216 is charged. The charge voltage is determined by the ratio of the capacitance of the ON capacitor 216b (Cap 2) to that of the second ON capacitor 233 (Cap 3). The charge voltage of the ON electrode 216 is no less than twice the voltage of the plate line 232 (PL) when the capacitance ratio is set at Cap 3>Cap 2.

Meanwhile, when the word line 231 (WL) is in a selected state (H level), the plate line 232 (PL) is discharged (e.g., 0 volts).

FIG. 10B is a functional circuit diagram showing an exemplary modification of the configuration of the pixel unit 211 according to the present embodiment.

The configuration shown in FIG. 10B is constituted by eliminating the ON capacitor 216b (Cap 2) connected to the ON electrode 216 from the configuration exemplified in the above described FIG. 10A.

However, the gate transistor 216c has a floating capacitance Cf at the source terminal that is connected to the ON electrode 216, and the floating capacitance Cf produces an effect similar to the effect produced by the eliminated Cap 2.

In this case, the capacitance of the second ON capacitor 233 is set at approximately the same capacitance as that of the OFF capacitor 215b (i.e., Cap 3=Cap 1). The floating capacitance Cf is usually very small, making it Cap 3>>Cf, and thus the charge of the ON electrode 216 becomes close to the voltage of the plate line 232 (PL).

FIG. 10C is a top view diagram of an exemplary layout, in the pixel unit 211, of the OFF capacitor 215b in the configuration exemplified in FIG. 10B and of the second ON capacitor 233 connected to the plate line 232, with the description assimilating the configurations described in FIGS. 8A through 8C.

Specifically, FIG. 10C is a diagram, as viewed from above, showing the top surface of the mirror 212 (or the mirror 913) and the layer in which the upper plate 233a of the second ON capacitor 233 (and OFF capacitor 215b) is positioned.

The second ON capacitor 233, the upper plate 233a, and lower plate 233b, that constitute the second ON capacitor 233 are of the same size, with the lower plate 233b placed right under the upper plate 233a.

Further, the upper plate 233a and lower plate 233b is smaller than the mirror 212 (or the mirror 913). This configuration prevents the size of the mirror device from increasing due to the second ON capacitor 233 jutting out from under the mirror 212.

FIG. 10D is a functional circuit diagram showing another exemplary modification of the configuration of the pixel unit 211 exemplified in FIG. 10A.

The exemplary modification shown in FIG. 10D is configured to have a second OFF capacitor 234 between the plate line 232 and OFF electrode 215, in addition to adding the second ON capacitor 233.

This configuration enables a control of the electric potential on the side of the OFF electrode 215 by way of the plate line 232 (PL), thus enabling a diverse control of the mirror 212.

FIG. 10E shows an exemplary configuration in which a second word line 231-2 and a second plate line 232-2 are added to the comprisal of the pixel array 210 (i.e., the pixel unit 211) exemplified in FIG. 10A.

The configuration of FIG. 10E is such that, in each of the plurality of pixel units 211 belonging to the same ROW line (ROW-n), a gate transistor 215c is connected to a word line 231, and a gate transistor 216c is connected to a second word line 231-2.

Furthermore, in the individual pixel units 211 belonging to the same ROW line (ROW-n), the second ON capacitor 233 is alternately connected to the plate line 232 or second plate line 232-2. For example, in the pixel unit 1-1, the second ON capacitor 233 is connected to the plate line 232, while in the next pixel unit 1-2, the second ON capacitor 233, is connected to the second plate line 232-2.

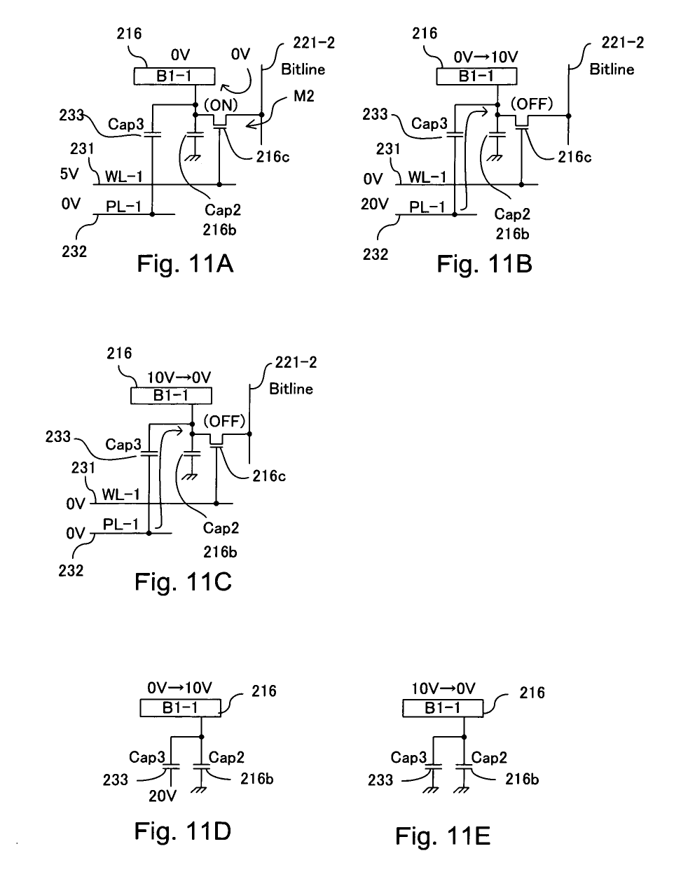

The following is a description of the operation of the ON electrode 216 near one pixel <pixel 1-1> shown in FIG. 10A and the operations of the word line 231 (WL-1) and plate line 232 (PL-1), with reference to FIGS. 11A through 11E.

Referring to FIG. 11A, the plate line 232 (PL-1) is at L level (0 volts) and “0” volts of the bit line 221-2 (Bitline) is applied to the ON electrode 216 by means of the H level (5 volts) of the word line 231 (WL-1).

Then, in FIG. 11B, the word line 231 (WL-1) is shifted to L level (e.g., 0 volts), which shifts the gate transistor 216c to OFF, and the ON electrode 216 is separated from the bit line 221-2 (Bitline), shifting the plate line 232 (PL-1) to H level (e.g., 20 volts). Thereby 10-volts is applied to the ON electrode 216 on the basis of the ratio of the capacitance (e.g., 1:1) of the second ON capacitor 233 (Cap 3) to that of the ON capacitor 216b (Cap 2). FIG. 11C shows a reverse operation as that described in FIG. 11B. While the word line 231 (WL-1) remained at L level (0 volts), the shifting of the plate line 232 (PL-1) to L (0 volts) changes the potential of the ON electrode 216 to 10 volts. FIG. 11D shows an equivalent circuit in the state of FIG. 11B. FIG. 11E shows an equivalent circuit in the state of FIG. 11C.

The above description has exemplified one case of Cap 2=15 femto farad (fF) and Cap 3=15 μl; if the Cap 2 is only the floating capacitance Cf of the gate transistor 216c, a voltage close to the potential of the plate line 232 (PL-1) will be applied to the ON electrode 216.

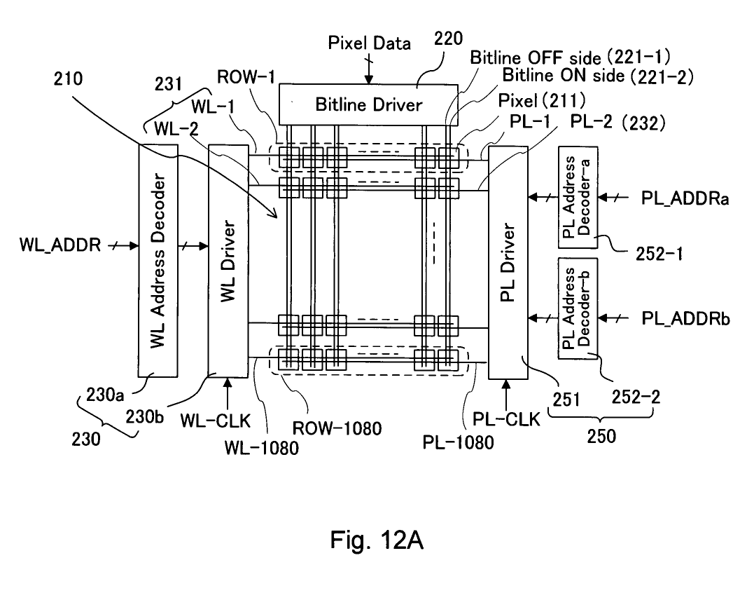

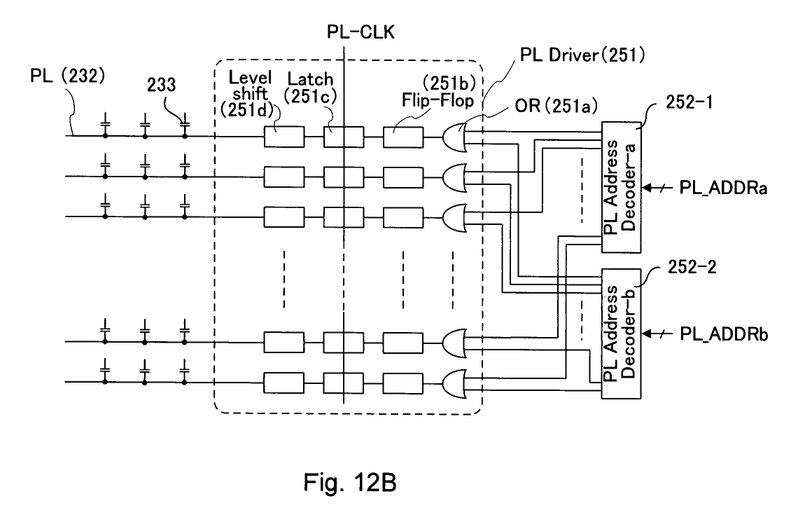

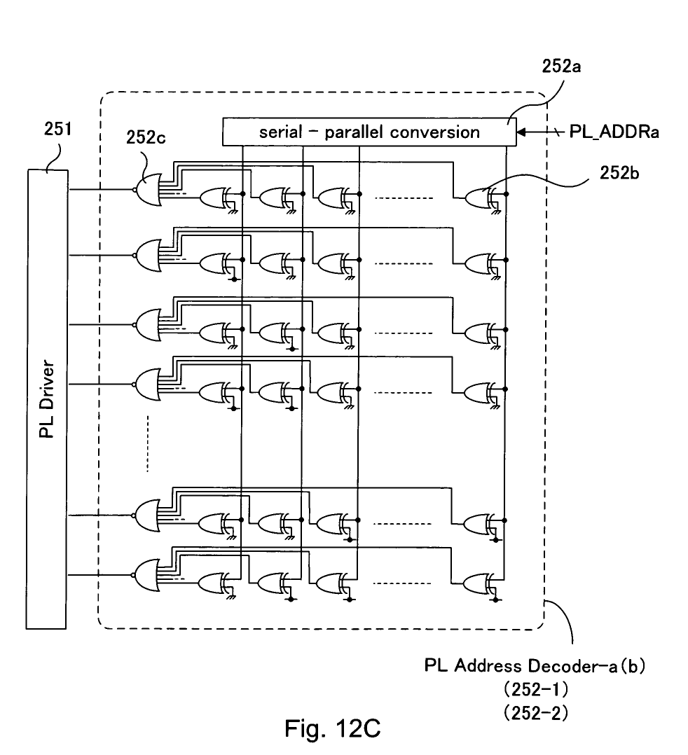

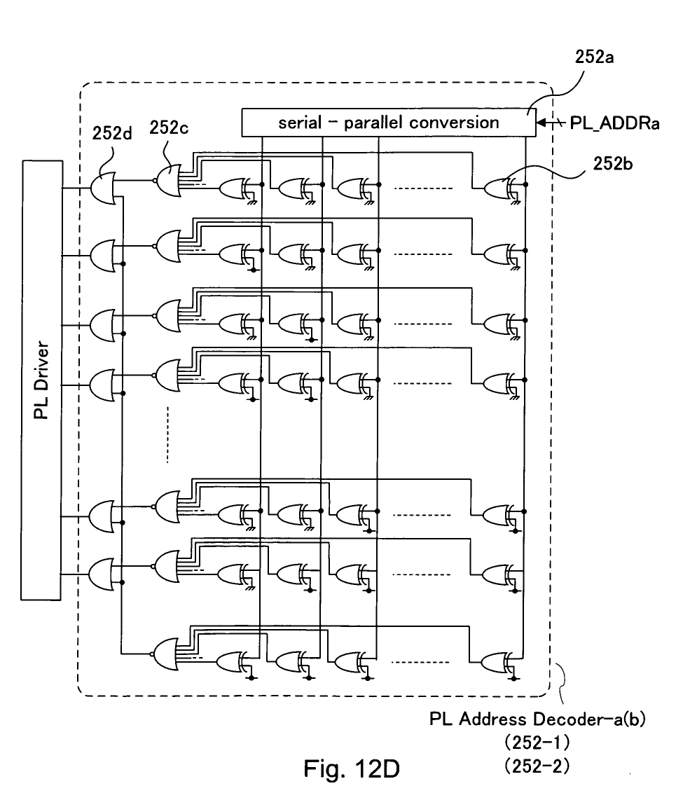

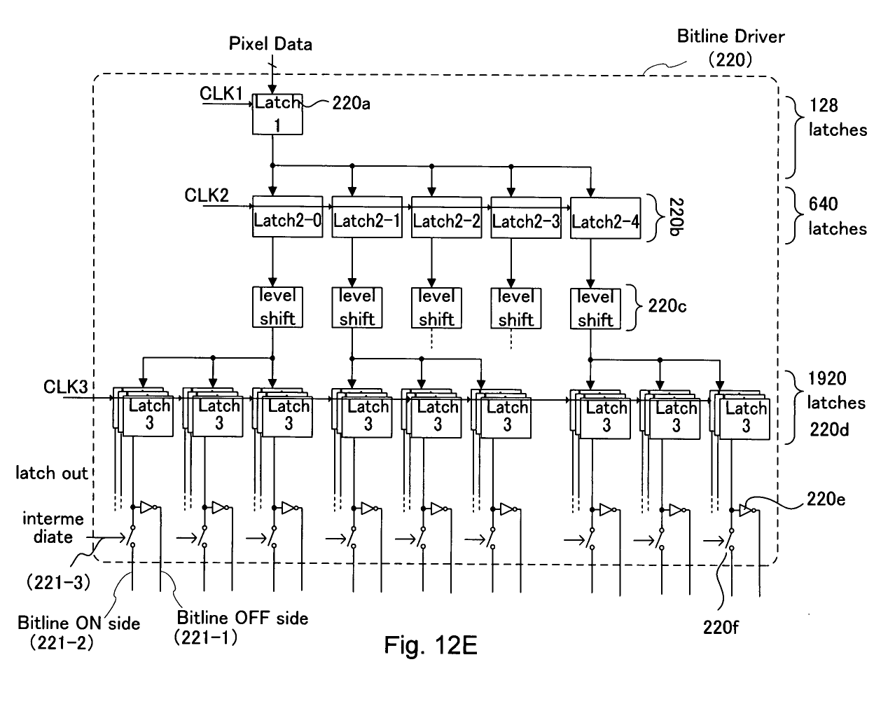

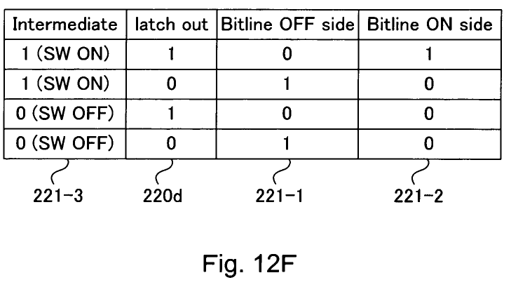

FIG. 12A exemplifies the configuration of placing the control circuit of the pixel array 210 arraying the pixel units 211 shown in FIG. 10A.

In order to control the plate line 232 added to the configuration of the pixel array 210 exemplified in FIG. 3, a plate line driver unit 250 is added.

Specifically, the present embodiment is configured to add the plate line driver unit 250 in the vicinity of the pixel array 210, in addition to the provision of the bit line driver part 220 and word line driver unit 230.

The word line driver unit 230 comprises a first address decoder 230a and a word line driver 230b that are used for selecting word lines 231 (WL).

The plate line driver unit 250 comprises a plate line driver 251, plate line address decoders 252-1 and 252-2, all of which are used for selecting plate lines 232 (PL).

Each pixel unit 211 is connected to the bit lines 221-1 and 221-2 of the bit line driver unit 220 (Bitline driver) so that data is written to the pixel units 211 belonging to the ROW line selected by a word line 231 (WL).

A signal produced by an external input data though a serial word line (WL_ADDR 1) is connected in parallel to an address decoder 230a (WL Address Decoder). A word line driver 230b (WL Driver) converts the input data into a designated voltage and applies the voltage to the word line 231 (WL).

Furthermore, the plate line 232 (PL) controls the ON electrode 216 of each pixel unit 211 y separately from the word line 231 (WL).

A plate line driver 251 (PL driver) converts the external input data PL_ADDRa or PL_ADDRb through series data line into a predefined voltage and apply the voltage through parallel signal lines to the plate line address decoder 252-1 (PL Address Decoder-a) and plate line address decoder 252-2 (PL Address Decoder-b) for selectively applied the signals to the plate line 232 (PL).

Specifically, the number of ROW lines, constituted by a plurality of pixel units 211 lined up horizontally, may be configured to be, for example, at least 720 lines or more.

In such a case, each data signal inputted to the memory cells M1 and M2, respectively, from the bit line 221-1 and 221-2, is transmitted to individual pieces of memory on one ROW line at the speed of 23 nanoseconds (nsec.) or slower.

That is, in order to process 720 ROW lines by dividing and assigning a display period into four colors, red (R), green (G), blue (B) and white (W) at the rate of 60 frames per second, with each color in 256-bit gray scale, the transmission speed is as follows:

1/60 [sec]/4 [divisions]/256 [bit gray scale]/720 [lines]=22.6 nsec.

Further, in order to process 1080 ROW lines by dividing and assigning a display period into three colors, R, G and B at the rate of 60 frames per second, with each color in 256-bit gray scale, the transmission speed is as follows:

1/60/3/256/1080=20 nsec.

FIG. 12B is a conceptual diagram exemplifying the internal configuration of the plate line driver 251 (PL Driver) exemplified in FIG. 12A.

The internal configuration of the plate line driver 251 (PL Driver) is comprised of circuits provided correspondingly to the plate lines 232 (PL).

In the plate line driver 251, an OR circuit 251a is equipped on the initial stage so as to enable either the plate line address decoder 252-1 (PL Address Decoder-a) or the plate line address decoder 252-2 (PL Address Decoder-b) to select a plate line 232 (PL).

The output of the OR circuit 251a is inputted to the flip-flop 251b (Flip-Flop), and the output value is retained therein.

Then, the output value is latched at the latch 251c (Latch) with a PL-CLK in order to synchronize with the bit line driver part 220 (Bitline driver). It is then converted by the level shift circuit 251d (Level shift) into the required voltage applied to the ON electrode 216.

FIG. 12C exemplifies the internal configuration of the plate line address decoder 252-1 (PL Address Decoder-a) exemplified in FIG. 12A.

The plate line address decoder 252-1 comprises a serial-parallel conversion circuit 252a for serial-to-parallel converting an externally serially inputted address signal (PL_ADDRa) into the number of bits of the plate lines 232, and an address detection unit constituted by EXOR circuits 252b and NOR circuits 252c, all of which are equipped for the number of bits of the PL_ADDRa.

An externally inputted address signal (PL_ADDRa) is serial-to-parallel converted by the serial-parallel conversion circuit 252a and is parallelly inputted to the respective EXOR circuits 252b.

If a plate line (PL) is the same as a plate line 232 (PL) selected by the parallel-converted value, the present PL is selected by the address detection unit (i.e., the EXOR circuit 252b and NOR circuit 252c) corresponding to the individual plate line 232.

Although not specifically shown in a drawing, the internal configurations of the plate line address decoder 252-2 (PL Address Decoder-b) and first address decoder 230a (WL Address Decoder) can be similar to that of the above described plate line address decoder 252-1.

FIG. 12D is a diagram showing an exemplary modification configured by adding a function to the address decoder exemplified in FIG. 12C.

If the number of plate lines 232 (PL) is, for example, 1080, a bit width required for the serial input of the PL_ADDRa is 11 bits. In this case, there is a surplus of 967 (=2047 (i.e., 11 bits)−1080).

If there is an address input (PL_ADDRa) of 1080 or more, those addresses are detected and all the plate lines 232 (PL) are selected in this case, and thereby, the pixel unit 211 can be reset with reset operations.

For this purpose, the exemplary configuration shown in FIG. 12D with the circuit further includes an OR circuit 252d for taking the logic sum of the outputs of all address detection units, in addition to the address detection units (i.e., the EXOR circuits 252b and NOR circuits 252c) corresponding to surplus address values.

This configuration makes it possible to detect a surplus address(es) if there is an input of 1080 addresses or more and select all plate lines 232 (PL) at the OR circuit 252d, thereby enabling a reset operation of the pixel unit 211.

FIG. 12E is a diagram exemplifying the internal configuration of the bit line driver unit 220 (Bitline Driver) exemplified in FIG. 12A.

The bit line driver unit 220 according to the present embodiment comprises a first stage latch 220a, a second stage latch 220b, a level shift circuit 220c, a third stage latch 220d, an inverter 220e and a mode changeover switch 220f.

The inverter 220e and mode changeover switch 220f function as column decoder for controlling the bit lines 221-1 and 221-2.

Specifically, the inverter 220e logically inverts the output (latch-out) from the third stage latch 220d to branch out as a bit line 221-1, while the mode changeover switch 220f turns ON/OFF the latch-out output to the pre-branched bit line 221-2.

If one ROW is, for example, 1920 bits, the bit line driver part 220 receives an external input that is 15 times of 128-bit pixel data.

The bit line driver part 220 latches this volume of data in three stages as follows:

First stage: 128 latches (at the first stage latch 220a)

↓

Second stage: 640 latches (at the second stage latch 220b)

↓

Voltage conversion (level shift) (at the level shift circuit 220c)

↓

Third stage: 1920 latches (at the third stage latch 220d)

As such, after performing 1920 latches at the third stage latch 220d, and when the data is sent to the ON side (i.e., the bit line 221-2) and OFF side (i.e., the bit line 221-1) of the Bitline, the respective logic states of the bit line 221-1 and bit line 221-2 are determined by a judgment logic on the basis of the table exemplified in FIG. 12F.

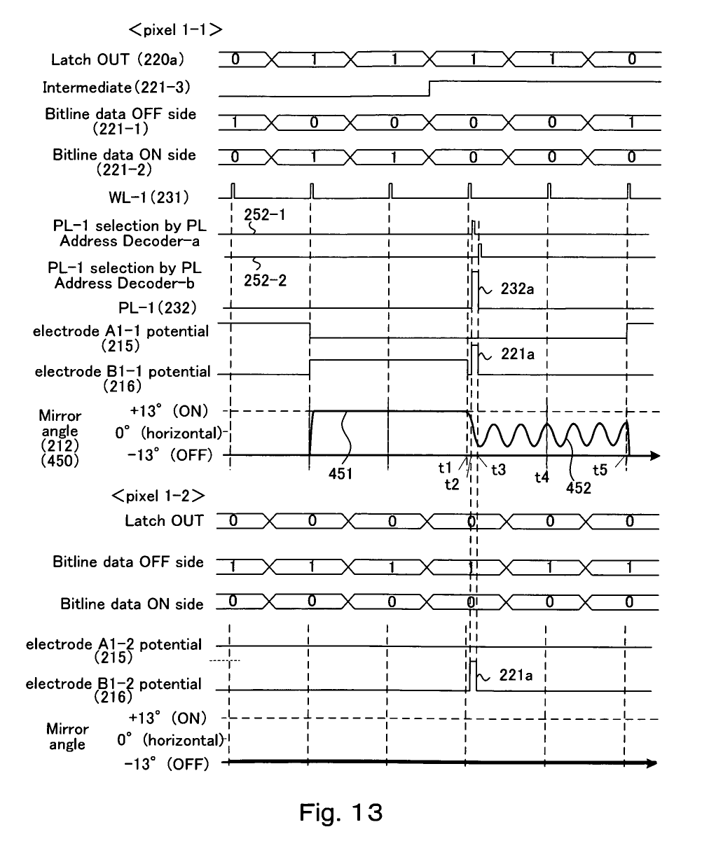

FIG. 13 is a timing chart depicting the relationship between (i) and (ii), where (i) is the operation timing of the <pixel 1-1> (i.e., pixel unit 211) and <pixel 1-2> (i.e., pixel unit 211) belonging to the same ROW line and (ii) is the state of the mirror 212 in the pixel array 210 exemplified in FIG. 10A.

In this case, the display states of the two pixel units 211 are a gray display for the <pixel 1-1> and a black display for the <pixel 1-2>.

The <pixel 1-1> and <pixel 1-2> belong to the same ROW line, and therefore, the mode changeover signal 221-3 (Intermediate), word line 231 (WL-1), and plate line 232 (PL-1) are common signals.

In the example shown in FIG. 13, the signal (WL) on a word line 231 is operated in a predetermined interval (i.e., one cycle of an interval between a control timing t1 and a control timing t4 in this case) in order to carry out the selection control of the bit line 221-1 and bit line 221-2.

In contrast, the signal (PL) on the plate line 232 is operated in an interval (i.e., control timing t1 and control timing t2) that is shorter than one cycle of the signal (WL) on a word line 231.

As an example, the signal (PL) is operated at two consecutive times (refer to the changes in the potentials 232a that is turned ON with the pulse of the plate line address decoder 252-1 and turned OFF with the pulse of the plate line address decoder 252-2) within the period of one cycle of the word line 231 in the example shown in FIG. 13.

Therefore, the transmission speed (i.e., the frequency) of a signal on the plate line 232 is faster than the transmission speed (i.e., the frequency) of a signal on the word line 231.

Until the control timing t1, the mirror 212 of the <pixel 1-1> remains deflected to the side of the ON electrode 216 if the Latch-OUT (i.e., the output of the third stage latch 220d) is “1” and to the side of the OFF electrode 215 if the Latch-OUT is “0”. That is, until the control timing t1, the operation of the mirror 212 is controlled by means of a pulse width modulation (PWM) in accordance with a PWM control profile 451.

Immediately prior to the control timing t1, the mirror 212 remains deflected to the side of the ON electrode 216. Then, at the control timing t1, the mode changeover signal 221-3 (Intermediate) is turned to be “H”, and (although the latch-OUT is “1”) the OFF electrode 215 and ON electrode 216 are turned to be “0” volts, prompting the mirror 212 to start a free oscillation.

At the control timing t2, the plate line 232 (PL-1) is selected by the plate line address decoder 252-1 (PL Address Decoder-a), and the PL-1 is turned to be an H level potential 232a (i.e., a potential higher than the H level potential 221a of the bit line 221 (bitline).

At the control timing t3, the plate line 232 (PL-1) is selected by the plate line address decoder 252-2 (PL Address Decoder-b), and the plate line 232 is turned to be L level.

During the period between the control timings t2 and t3, the mirror 212 is drawn back to the side of the ON electrode 216 and starts an intermediate oscillation (OSC) as shown by an intermediate oscillation control profile 452.

Then, at the control timing t5, after passing the control timing t4, an “H” is set by the bit line 221-1 (Bitline) at the side of the OFF electrode 215, and the mirror 212 is drawn to the OFF electrode 215 and remains stationary in the OFF state.

Meanwhile, the mirror 212 of the <pixel 1-2> needs remain stationary on the side of the OFF electrode 215 for displaying black.

The plate line 232 (PL-1) is common to <pixel 1-2> and <pixel 1-1>, and therefore during the period between the control timings t2 and t3, a voltage (i.e., the potential 221a) is generated at the ON electrode 216. However, the mirror 212 is stationary on the OFF side and the distance between the ON electrode 216 and mirror 212 is large, and therefore the Coulomb force applied to the mirror 212 is weak and the position thereof will not be changed.

Note that the interval between the control timings t1 and t2 (i.e., a predetermined delay time) can be set to be the same (i.e., constant) within one frame.

Further, the above described predetermined delay time can be determined by the intensity of illumination light or the intensity of the reflection light of the mirror 212 of a pixel unit 211.

Note that, in FIG. 13, the intermediate oscillation starts at a PWM ON. If it starts at OFF, the method is to connect the plate line (232) to the memory on the OFF side, connect the capacitor of the ON side memory to the ground, set the potential of the electrode A1-1 at “H” and the potential of the electrode B1-1 at “L” at the timing t1, and apply a voltage to the electrode A1-1 from the plate line (232) at the control timing t2 and t3.

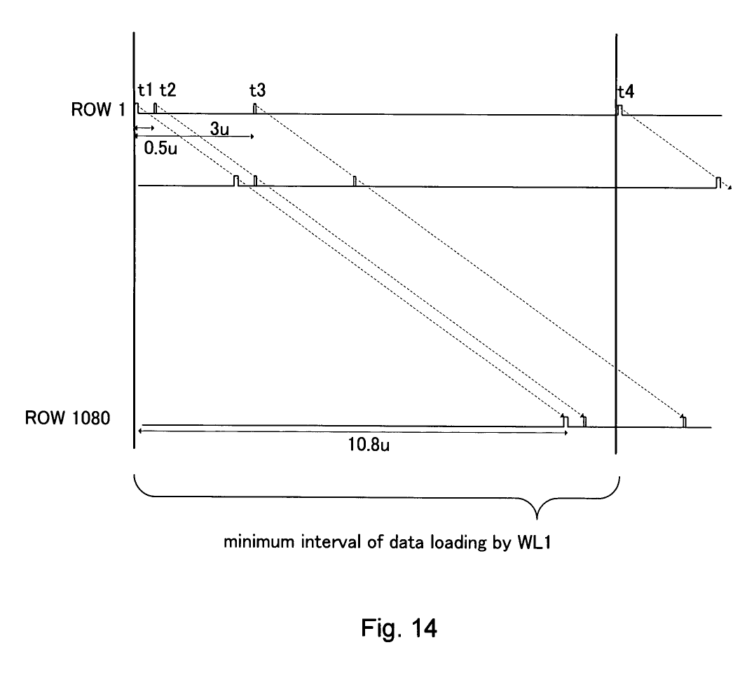

FIG. 14 is a timing chart of the ROW lines and address decoder which are exemplified in FIG. 12A. The control timings t1, t2, t3 and t4 correspond to the timings t1 through t4 shown in FIG. 13.

On the ROW 1, at the control timing t1, the word line 231 (WL-1) carries out a data loading and then the first address decoder 230a (WL_ADDR1) selects ROW 2, 3, 4 through 1080 sequentially to carry out data loadings.

At the control timing t2, the plate line address decoder 252-1 (PL_ADDRa) selects the plate line 232 (PL-1).

The plate line address decoder 252-1 (PL_ADDRa) selects PL-2, 2-3, 2-4 through 2-1080 sequentially.

At the control timing t3, the plate line address decoder 252-2 (PL_ADDRb) selects the plate line 232 (PL-1).

The plate line address decoder 252-2 (PL_ADDRb) selects PL-2, 2-3, 2-4 through 2-1080 sequentially.

As such, the control of the intermediate oscillation of all ROW lines is enabled in the minimum interval (i.e., during the period between control timings t1 and t4) of data loading performed by the word line 231 (WL).

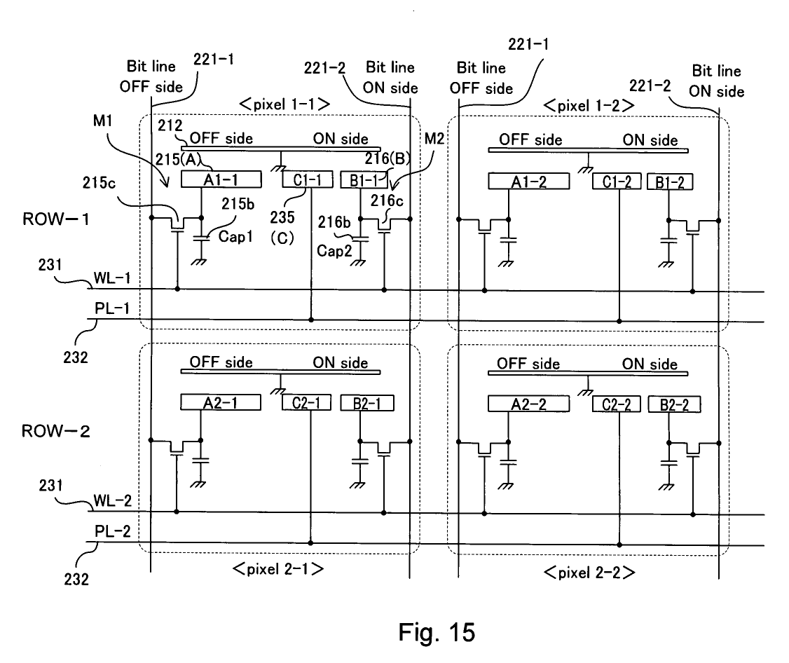

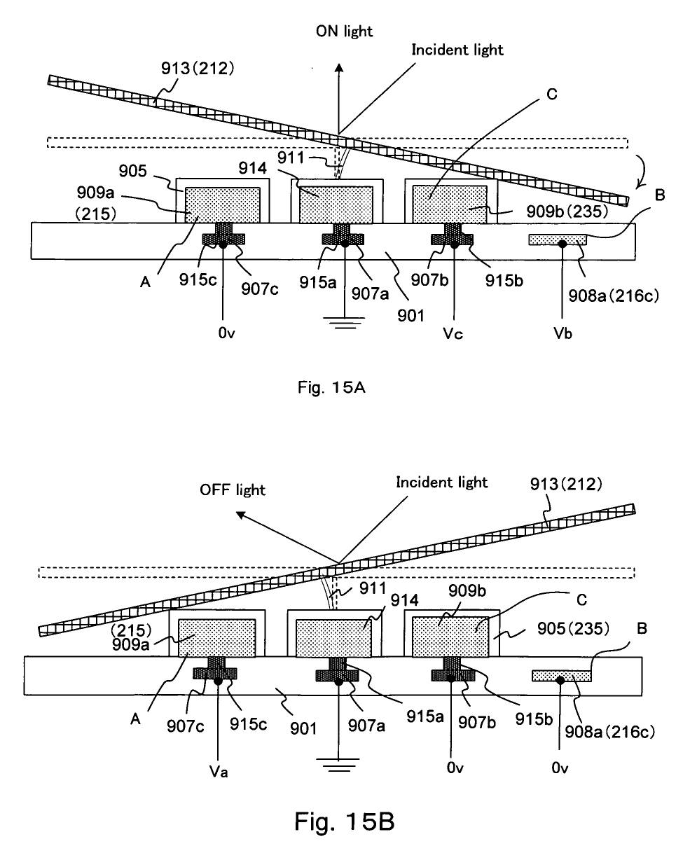

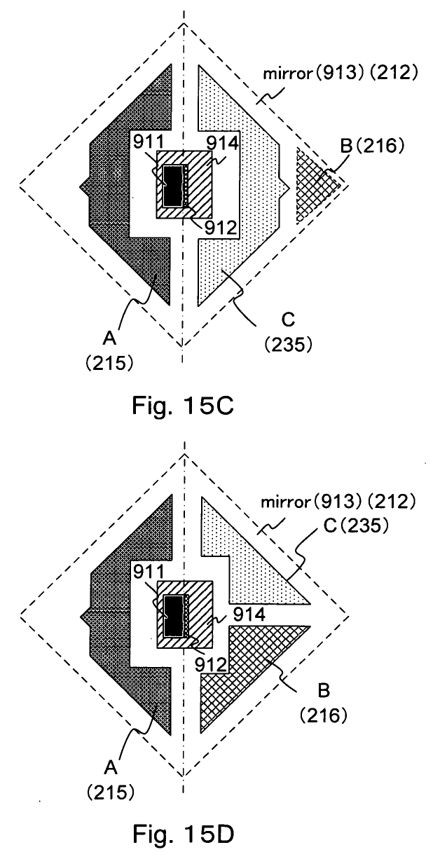

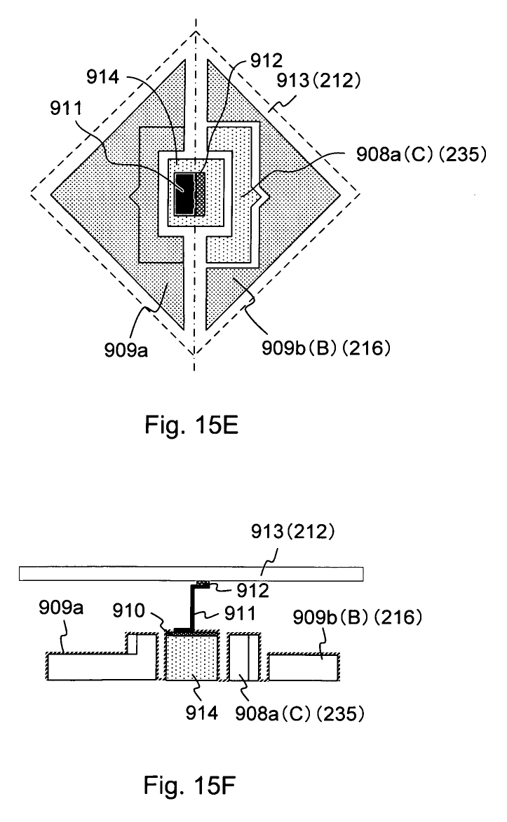

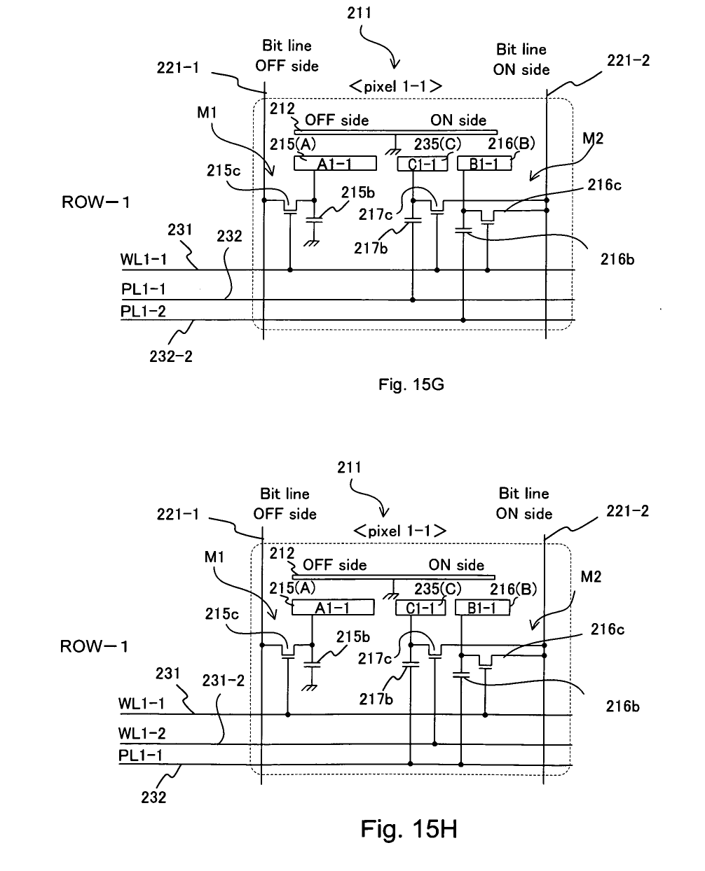

FIG. 15 is a functional circuit diagram showing another exemplary modification of the pixel unit 211. FIG. 15 shows the configuration of equipping a second ON electrode 235 (i.e., an electrode C) connected directly to the plate line 232, in addition to comprising the ON electrode 216 (i.e., the electrode B).

Specifically, in contrast to the configuration of controlling the ON electrode 216 by means of the plate line 232 (PL), exemplified in FIG. 12A, in which two electrodes, the OFF electrode 215 and ON electrode 216, are equipped for one pixel, the pixel unit 211 exemplified in FIG. 15 is configured to add a second ON electrode 235 (i.e., an electrode C) and connect the plate line 232 (PL) directly to the electrode C without an intervention of a circuit element.

The drive circuit for the pixel unit 211 exemplified in FIG. 15 is the same as that shown in FIG. 12A.

FIGS. 15A and 15B are cross-sectional diagrams, in an ON state and an OFF state, respectively, of a pixel unit 211 comprising two electrodes, i.e., an ON electrode 216 and a second ON electrode 235, on the ON side exemplified in FIG. 15.

Note that the component designations used in FIGS. 15A and 15B are the same as those in FIG. 8A.

FIGS. 15C and 15D are illustrative top view diagram showing an exemplary layout of the added second ON electrode.

The configuration of FIG. 15D exemplifies the configuration in which the surface electrodes 909b and 908a, which constitute the ON electrode 216 in the configuration exemplified in FIG. 8B, are electrically mutually independent. They are connected to the plate line 232 (PL), and thereby, the function of the second ON electrode 235 (i.e., the electrode C) is controlled.

Further, FIG. 15D shows a configuration in which the surface electrode 908a, of the surface electrodes 909b and 908a comprised in the configuration shown FIG. 8C, is eliminated and the area of the surface electrode 909b is enlarged and divided into two parts, the ON electrode 216 (i.e., the electrode B) and the second ON electrode 235 (i.e., the electrode C).

FIG. 15E is a top view diagram showing another exemplary layout of the electrode B connected to the word line 231 and the electrode C connected to the plate line 232; and FIG. 15F is the cross-sectional diagram of the configuration in FIG. 15E.

In this case, the electrode C (i.e., the surface electrode 908a) connected to the plate line 232 is placed close to the elastic hinge 911 in an inverted, rectangular “C” shape, so as to surround the present elastic hinge 911, and further, the electrode B connected to the word line 231 is positioned to surround three sides of the electrode C.

FIG. 15G is configured, in the pixel unit 211 exemplified in FIG. 15, to add a second ON capacitor 217b and a second ON gate transistor 217c, both of which are for controlling the second ON electrode 235, and also to add a second plate line 232-2.

Further in the configuration, the second ON capacitor 217b is connected to the plate line 232, and the second ON capacitor 217b is connected to the newly added second plate line 232-2.

FIG. 15H differs from the above described FIG. 15G in that the former is equipped with a second word line 231-2 in place of the second plate line 232-2.

Further, the gate of the second ON gate transistor 217 of the second ON electrode 235 is connected to, and controlled by, the second word line 231-2.

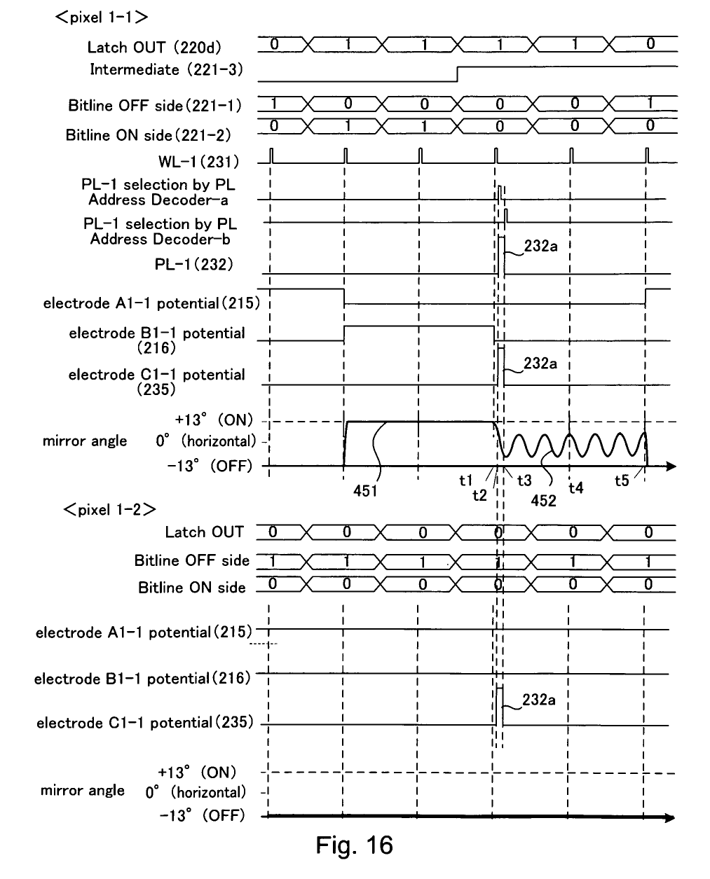

FIG. 16 is a timing chart showing the operational timings of the <pixel 1-1> and <pixel 1-2>, both of which belong to the same ROW line, and the operation of the mirror 212 in the pixel unit 211 equipped with the second ON electrode 235, as exemplified in FIG. 15. In this example, the <pixel 1-1> displays gray, while the <pixel 1-2> displays black.

Since the two pixels belong to the same ROW line, the mode changeover signal 221-3 (Intermediate), word line 231 (WL-1), and plate line 232 (PL-1) are common signals to the <pixel 1-1> and <pixel 1-2>.

In contrast to the timing chart in FIG. 13, the chart shown in FIG. 16 is such that the waveforms of the ON electrode 216 (i.e., the electrode B) and second ON electrode 235 (i.e., the electrode C) are depicted when attracting the mirror 212 from the ON state to the oscillation state.

Specifically, in the case of FIG. 16, the mirror 212 is attracted to the oscillation state by changing the potential of the second ON electrode 235 (i.e., the electrode C) to a potential 232a with the plate line 232, instead of changing the potential of the ON electrode 216.

As such, this configuration, equipped with the second ON electrode 235 controlled with the plate line 232, makes it possible to apply a voltage to the second ON electrode 235 independently from the signals from the bit lines 221-1 and 221-2, thus enabling a temporarily finer operational control than the control by means of, for example, only the word line 231 or other similar control.

Further, the control from the plate line 232 makes it possible for a plurality of voltages to be applied to the address electrodes, such as the second ON electrode 235 and ON electrode 216, thereby attaining more complicated operational control.

This configuration enables a sufficient level of drive voltage for the memory cell M2 and a control for high speed timing in applying the voltage, thereby attaining a control for high speed operation of the mirror 212.

Incidentally, bit data is ignored in the exemplary configuration shown in FIG. 15, and therefore the drive voltage is increased together for each line of the plate lines 232. In this case, such a lump control for each line of the plate lines 232 does not create a problem because it is an amplitude adjustment in the oscillation control for the mirror 212.

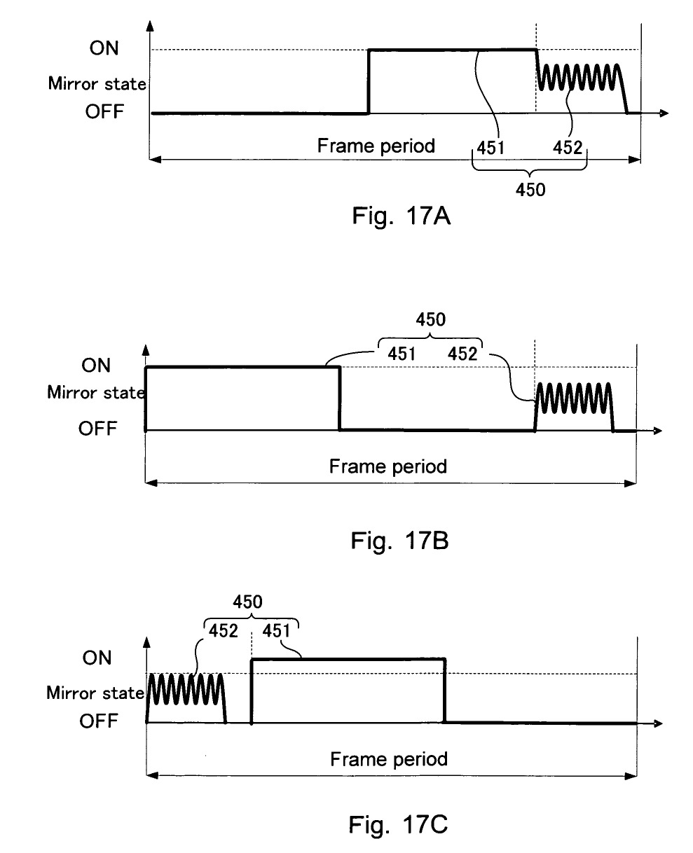

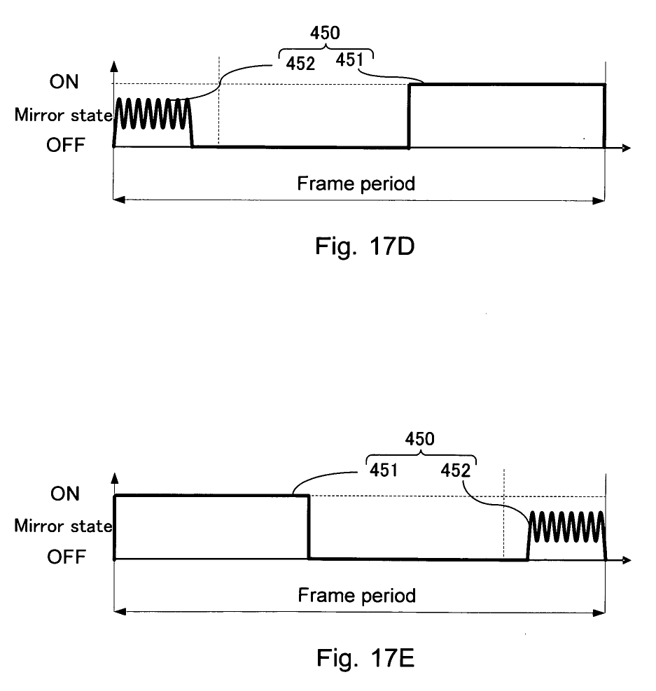

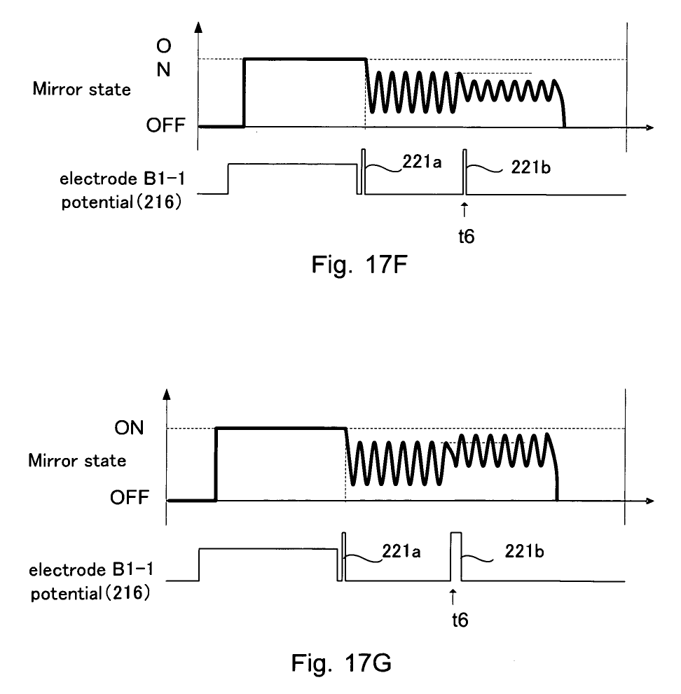

FIG. 17A, through 17E are charts showing various exemplary placements of a PWM control profile 451 (PWM drive timing 440) and an intermediate oscillation control profile 452 (OSC drive timing 441 in the mirror control profile 450) for one frame period of a mirror.

The mirror control profile shown in FIG. 17A exemplifies the case of sequentially generating a PWM control profile 451 and an intermediate oscillation control profile 452 in the latter part of one frame.

FIG. 17B exemplifies the case of generating the PWM control profile 451 in the beginning of one frame and generating the intermediate oscillation control profile 452 towards the end of the same frame.

FIG. 17C exemplifies the case of generating the intermediate oscillation control profile 452 in the first half of one frame and then generating the PWM control profile 451.

FIG. 17D exemplifies the case of generating the intermediate oscillation control profile 452 at the start of one frame and generating the PWM control profile 451 at the end thereof.

FIG. 17E exemplifies the case of aligning the ON position of the PWM control profile 451 with the beginning of one frame and aligning the end of the intermediate oscillation control profile 452 with the end of the same frame.

The operational pattern (i.e., the intermediate oscillation control profile 452) of the mirror 212 of the pixel displaying gray (i.e., <pixel 1-1>) shown in the above described FIGS. 13 and 16 corresponds to FIG. 17A.

Note that the present embodiment is also configured to be capable of changing oscillation states in the midst of an intermediate oscillation (i.e., the intermediate oscillation control profile 452).

FIGS. 17F and 17G show the state of the mirror 212 when a voltage is re-applied, from the plate line 232 (PL), to the ON electrode 216 (i.e., the electrode B) in the midst of an intermediate oscillation, for example, under the control shown in FIG. 13.

Referring to FIGS. 17F and 17G, a re-application voltage 221b is generated at the ON electrode 216 at the control timing t6, so that the waveforms of the intermediate oscillation are changed by the application timing, the application period, and the applied voltage value of the re-application voltage.

In FIG. 17F, as an example, the application period of the re-application voltage 221b is relatively short, and therefore the center of the oscillation of the mirror 212 does not change; rather, only the amplitude becomes smaller.

In contrast, FIG. 17G shows that the application period of the re-application voltage 221b is relatively long, and therefore the center of the oscillation of the mirror 212 is biased to the ON side, instead of the center.

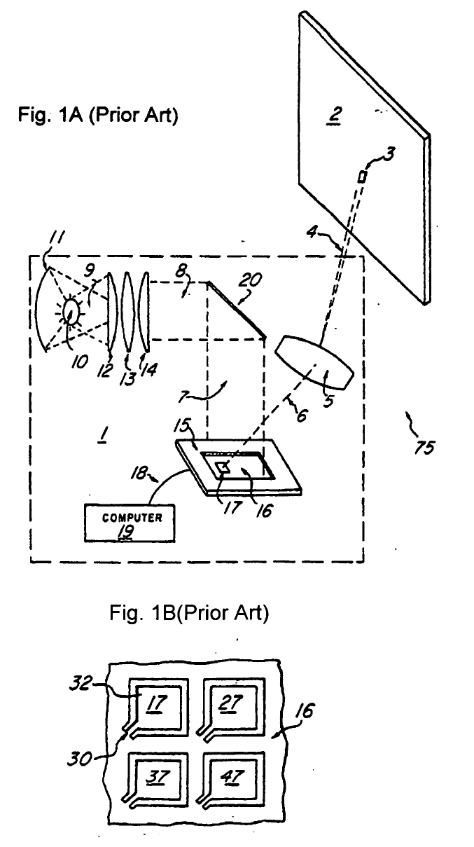

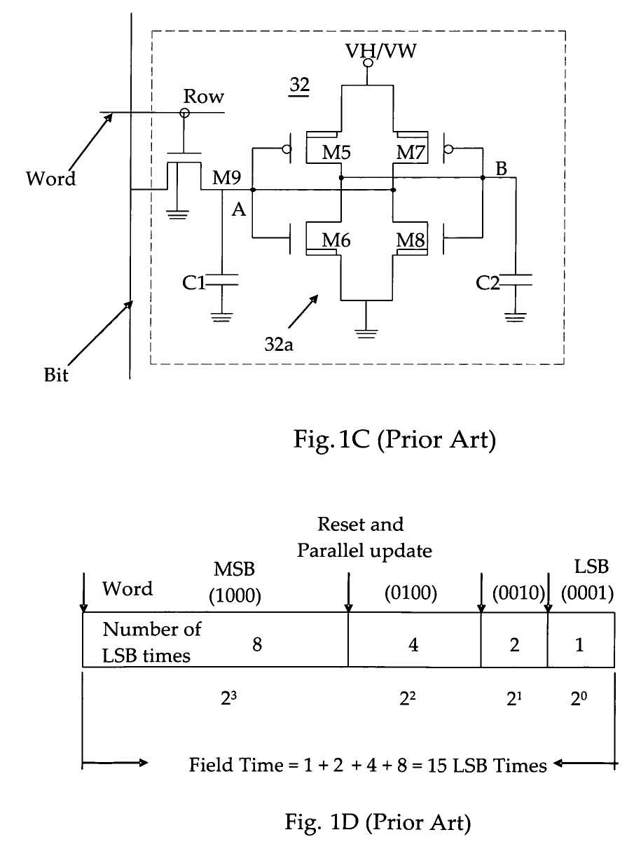

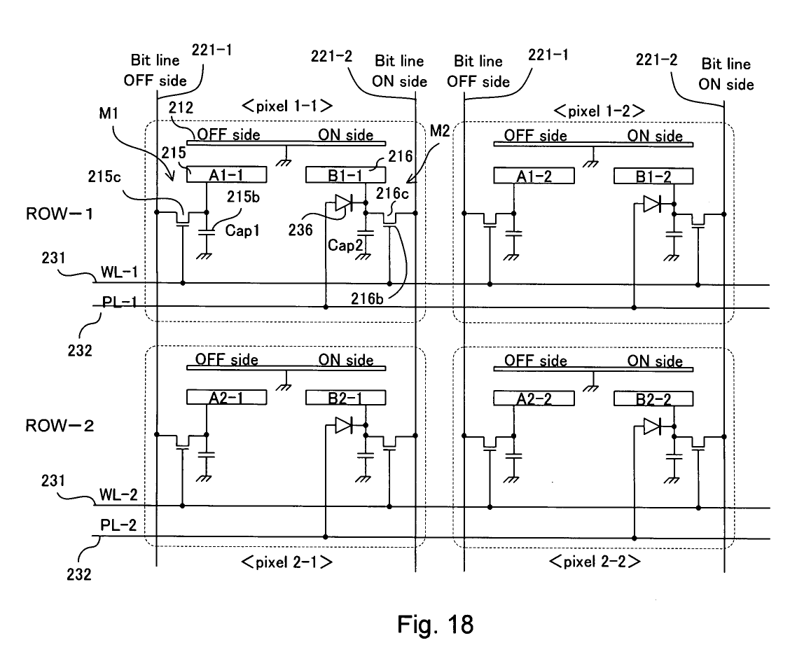

FIG. 18 exemplifies the case of placing a diode 236 in place of the second ON capacitor 233 in the configuration of the pixel unit 211 exemplified in FIG. 1A.

The drive circuit for the pixel unit 211, in this case, is the same as FIG. 12A. The drive timing, however, uses the bit line 221-1 (Bitline) at the end of reversing the movement of the mirror 212, as described later.

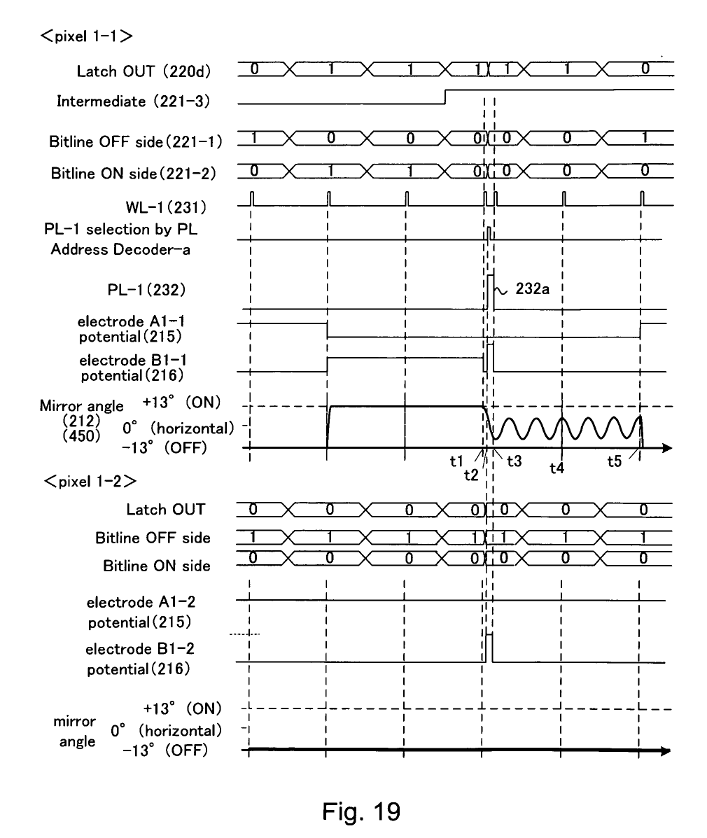

FIG. 19 is a timing chart exemplifying the state of the mirror 212 and the operational timing of <pixel 1-1> and <pixel 1-2> that belong to the same ROW line of the pixel array 210 exemplified in FIG. 18. In this example, the <pixel 1-1> displays gray, while the <pixel 1-2> displays black.

Since the two pixels belong to the same ROW line, the mode changeover signal 221-3 (Intermediate), word line 231 (WL-1), and plate line 232 (PL-1) are common signals to the <pixel 1-1> and <pixel 1-2>.

The exemplary control shown in FIG. 19 differs from the exemplary control shown in FIG. 13 in that the former discharges the ON electrode 216 at the control timing t3 with the bit line 221-1 (bit line) and word line 231 (WL) (refer to the waveform at the control timing t3 in the word line 231).

Therefore, only one PL Address Decoder (i.e., the plate line address decoder 252-1 and plate line address decoder 252-2) is required.

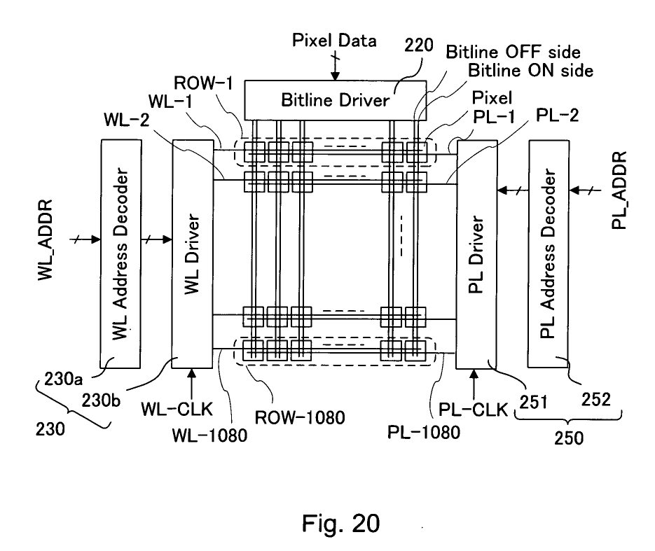

FIG. 20 exemplifies the relationship of connection between the address decoder and bit line driver part 220 (Bitline driver) that are used for selecting the word line 231 (WL) and plate line 232 (PL) of the pixel array 210.

As exemplified in FIG. 20, this is a simple configuration connecting one plate line address decoder 252 to the plate line driver 251, in place of connecting two plate line address decoders 252-1 and 252-2 thereto.

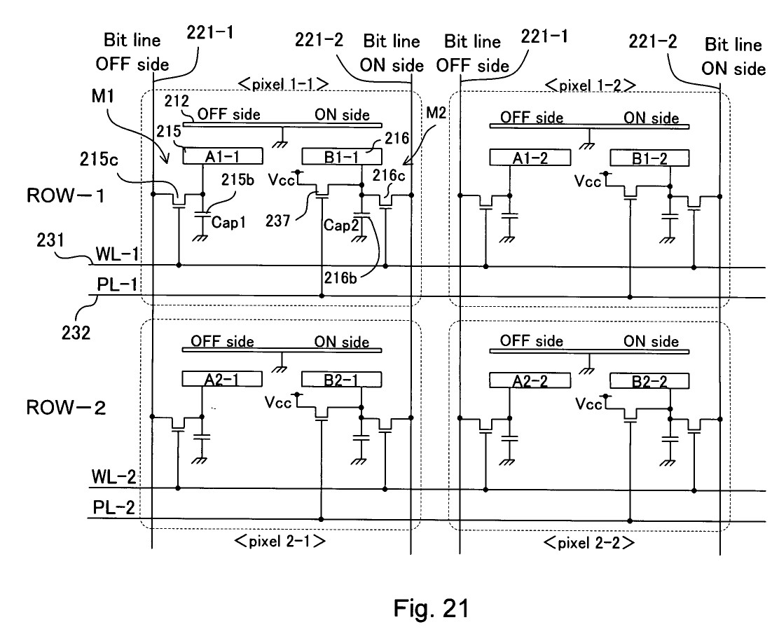

FIG. 21 shows another exemplary modification of the configuration of the pixel unit 211 according to the present embodiment.

The configuration shown in FIG. 21 places a field effect transistor 237 (FET) in place of the second ON capacitor 233, as shown in the configuration of the pixel unit 211 exemplified in FIG. 1A.

Specifically, the plate line 232 is connected to the gate electrode of the field effect transistor 237, and whether or not a power source voltage Vcc, to which the drain of the field effect transistor 237 is connected, is to be applied to the ON capacitor 216b is controlled by the applied voltage from the plate line 232.

The drive circuit for the pixel unit 211 according to the exemplary modification shown in FIG. 21 is the same as in FIG. 12A.

The drive timing of the pixel unit 211 comprising the field effect transistor 237 is controlled in the same manner as that of the circuit shown in FIG. 12A, whereas the setup voltage from the plate line 232 (PL) to the ON electrode 216 is determined by the power source voltage Vcc, to which the drain of the FET is connected, instead of being determined by the voltage of the plate line 232 (PL).

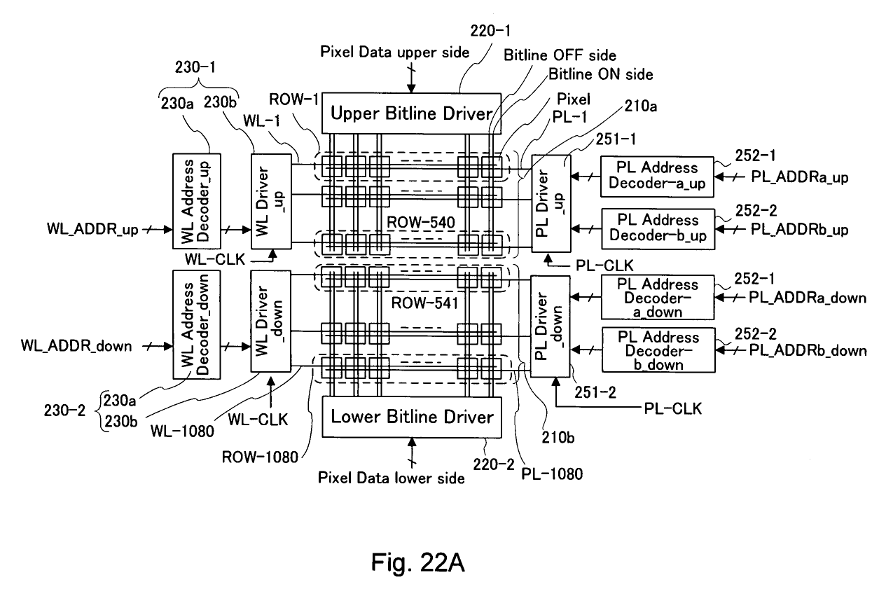

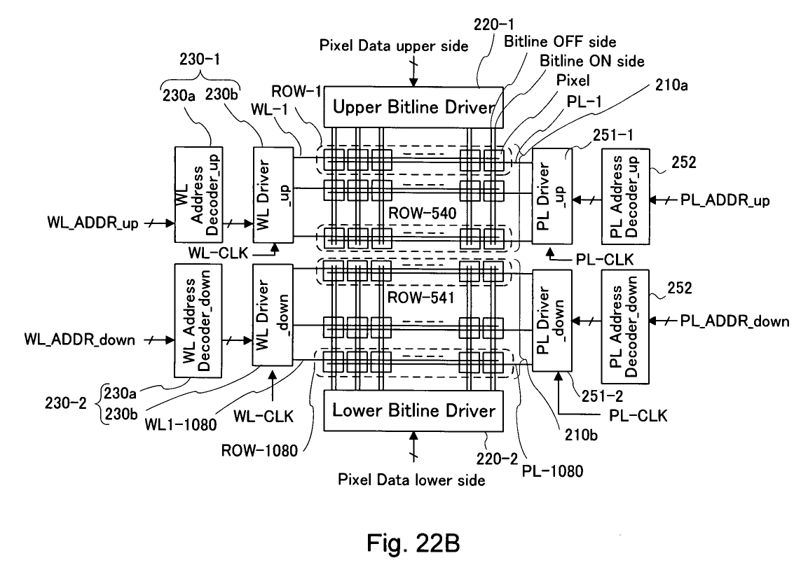

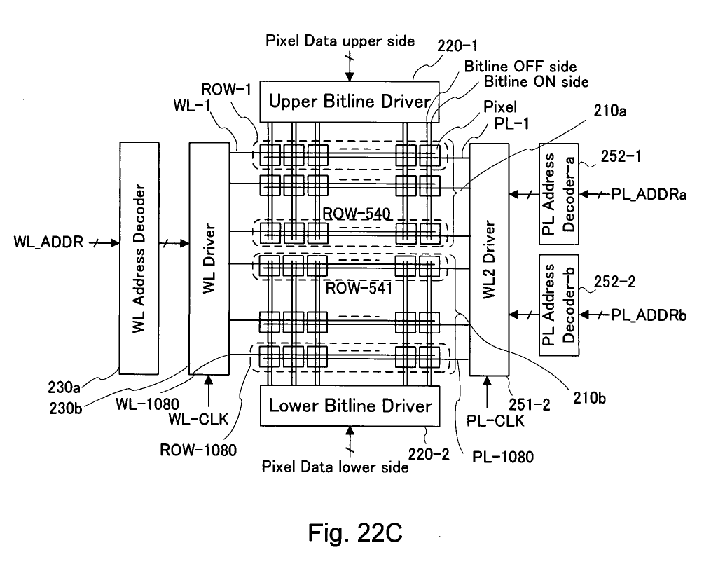

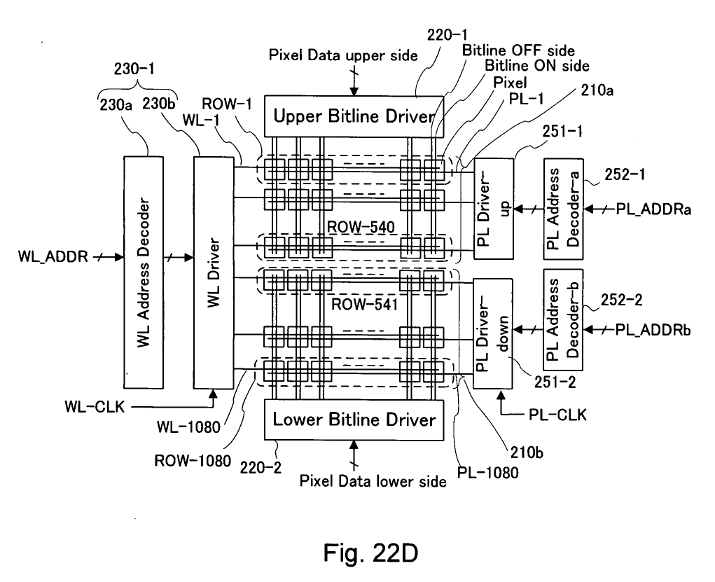

FIG. 22A is a functional circuit diagram showing an exemplary modification of the configuration of the pixel array 210 according to the present embodiment.

The configuration exemplified in FIG. 22A divides a plurality of ROW lines (ROW-1 through ROW-1080) into upper and lower groups (i.e., an upper row line area 210a and a lower row line area 210b, and comprises, for each group, an upper bit line driver part 220-1 and a lower bit line driver part 220-2 (Bitline Driver), a first address decoder 230a and a word line driver 230b (WL Address Decoder_up and WL Driver_up, WL Driver_down and WL Driver_down), a plate line driver 251-1 and a plate line address decoder 252-1, a plate line address decoder 252-2 (PL Address Decoder-a_up and PL Driver_up, PL Address Decoder-a_down, b_down and PL Driver_up, down).

That is, a plurality of row lines are divided into the upper row line area 210a, which is constituted by the row lines ROW-1 through ROW-540, and the lower row line area 210b, which is constituted by the row lines ROW-541 through ROW-1080.

In this case, the level change (i.e., the voltage Vd) of the plate line 232 is accomplished by changing the plate line address decoder 252-1 changing to H level and the plate line address decoder 252-2 to L level.

FIG. 22B shows an exemplary configuration in which the plate line driver 251-1 (PL Driver_up) and plate line driver 251-2 (PL Driver_down) that are equipped, respectively, for the upper and lower ROW line groups is equipped with one plate line address decoder 252 (PL Address Decoder_up) and one plate line address decoder 252 (PL Address Decoder_down) in the comprisal of the pixel array 210 shown in the above described FIG. 22A.

In this case, the level change (i.e., the potential 232a) of the plate line 232 (PL) is carried out by the plate line 232 (PL).

FIG. 22C shows the configuration in which a first address decoder 230a and a word line driver 230b, a plate line driver 251 and a plate line address decoder 252-1 and a plate line address decoder 252-2 are equipped for each group in the configuration in which the ROW lines of a pixel array 210 is divided into the upper and lower groups, and each of the upper and lower ROW line groups is equipped with the upper bit line driver part 220-1 and lower bit line driver part 220-2.

In this case, for each group of the upper and lower ROW lines, the ROW lines applicable to the same address will be driven simultaneously; a combination of the respective ROW lines in the upper and lower groups to be simultaneously driven is determined by wirings.

For example, the ROW lines applicable to the same address (in the example of FIG. 22C, the first ROW-1 in the upper group and the first ROW-541 in the lower group) are simultaneously driven.

FIG. 22D shows an exemplary configuration in which the plate line driver 251 commonly equipped in the upper and lower groups is separated into a plate line driver 251-1 (PL Driver_up) corresponding to the upper group and a plate line driver 251-2 (PL Driver_down) corresponding to the lower group and the divided drivers are placed correspondingly to the respective groups, according to the configuration of the pixel array 210 shown in FIG. 22C.

In this case, the ROW lines belonging to the upper and lower groups are individually driven, unlike the configuration shown in FIG. 22C.

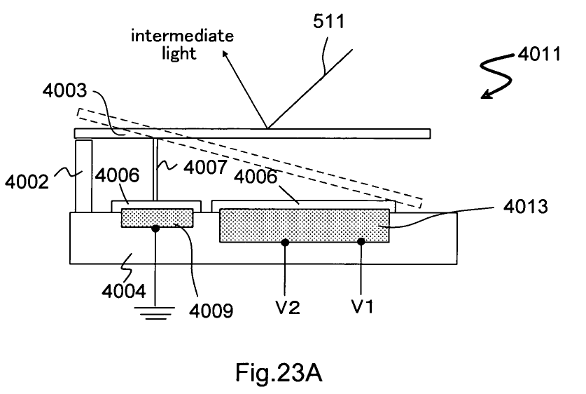

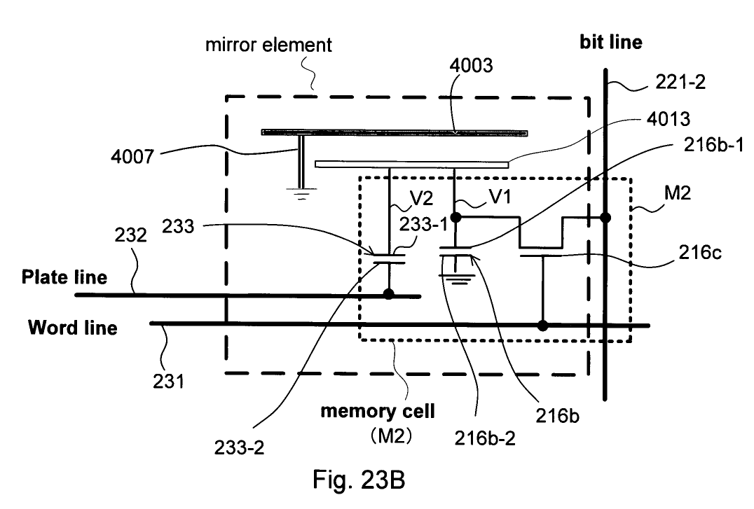

FIG. 23A is a cross-sectional diagram showing an exemplary modification of the configuration of a pixel unit 211 (i.e., a mirror element 4011) according to the present embodiment; and FIG. 23B is a conceptual diagram showing an exemplary configuration of the drive circuit for the pixel unit.

The mirror element 4011 (i.e., the pixel unit 211) according to the present embodiment comprises a hinge electrode 4009 and an address electrode 4013, both of which are placed on a device substrate 4004 and are covered with an insulation layer 4006.

A mirror 4003 is supported on the insulation layer 4006 of the hinge electrode 4009 by an elastic hinge 4007. In this case, the mirror 4003 is supported as a cantilever against the elastic hinge 4007, with the entirety of the mirror 4003 protruding over an address electrode 4013.

A stopper 4002 is placed on the other side of the address electrode 4013, to the left of the elastic hinge 4007, with the end of the stopper 4002 fixed onto the device substrate 4004.

The mirror 4003 is tilted, towards the address electrode 4013, by a Coulomb force resulting from applying a voltage V1 to the address electrode 4013 and is stopped at a position abutting on the insulation layer 4006 covering the address electrode 4013 (this position is known as an ON state).

Further, when the application of the voltage V1 to the address electrode 4013 is cut off, the mirror 4003 is shifted by the elasticity of the elastic hinge 4007 back to the horizontal state, abutting the stopper 4002, which stops the shift (this position is known as an OFF state).

The following is a description of a control circuit for the mirror element 4011, as exemplified in FIG. 23B. In this case, the mirror element 4011 is supported by the elastic hinge 4007 in a cantilever and therefore is a configuration equipped with the bit line 221-2, gate transistor 216c, ON capacitor 216b and word line 231, which are the circuit elements of the memory cell M2 on the ON side, as exemplified in FIG. 10A.

Furthermore, as shown in FIG. 10A, the present embodiment is configured to be equipped with the plate line 232, in addition to the word line 231, and to connect the plate line 232 to the address electrode 4013 by way of the second ON capacitor 233.

Specifically, the first plate 216b-1, of a pair of plates of the ON capacitor 216b, is connected to the address electrode 4013, while the second plate 216b-2 is connected to a fixed potential such as the ground potential.

Further, the first plate 233-1, of a pair of plates of the ON capacitor 233, is connected to the address electrode 4013, while the second plate 233-2 is connected to the plate line 232.

By controlling the word line 231, plate line 232 and bit line 221-2, the mirror 4003 is controlled to be in the OFF state, ON state, and the intermediate oscillation state.

The following is a description of an exemplary method for controlling the pixel array 210 comprising the cantilever-structured mirror 4003 exemplified in FIGS. 23A and 23B. Note that the control system can use the configuration as exemplified in FIG. 12A.

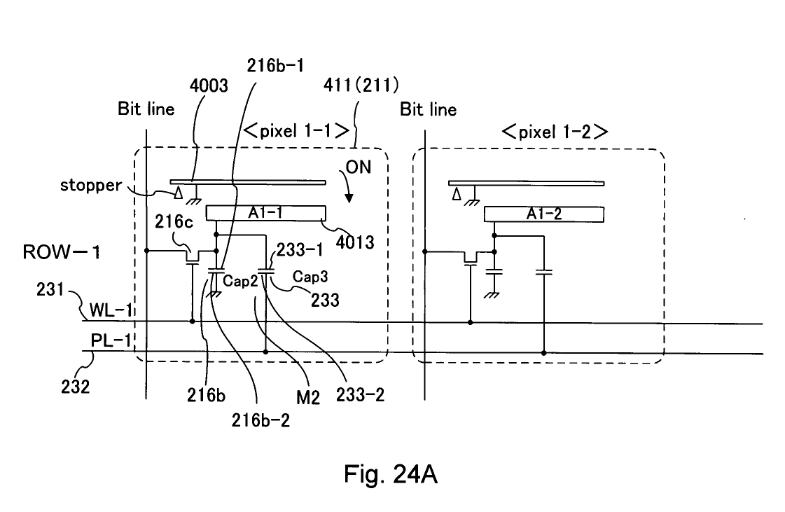

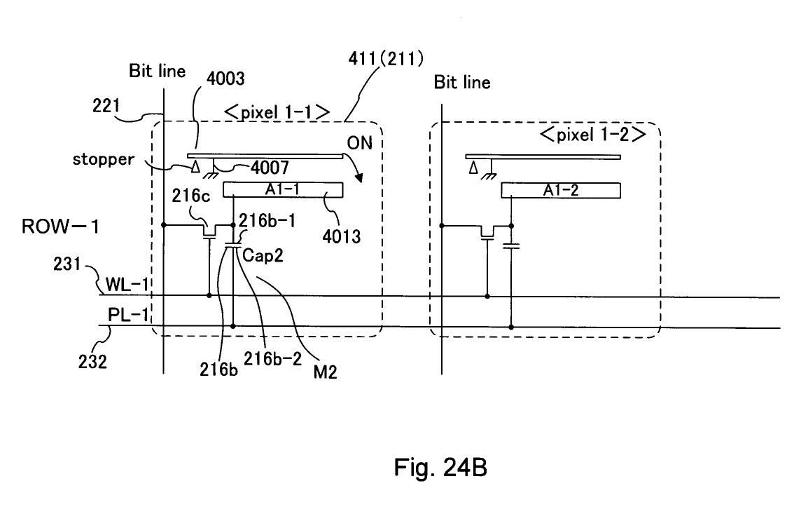

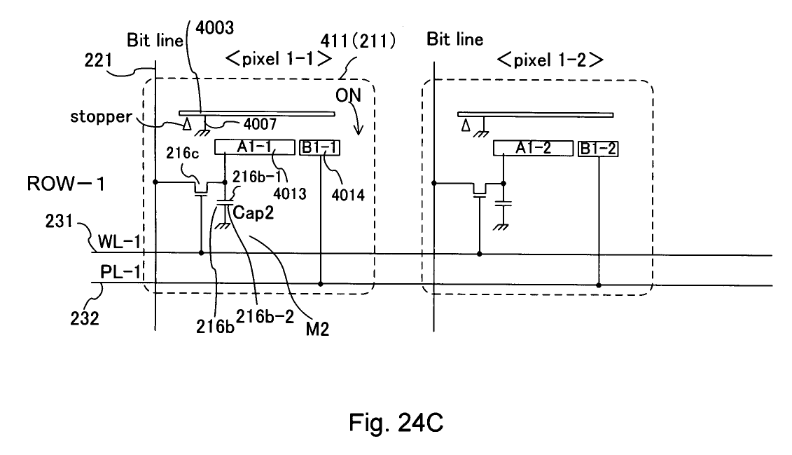

FIG. 24A is a circuit diagram extracting and exemplifying a part of the layout of the pixel array 210 comprising a mirror 4003 (shown in FIG. 23B) that is structured as a cantilever.

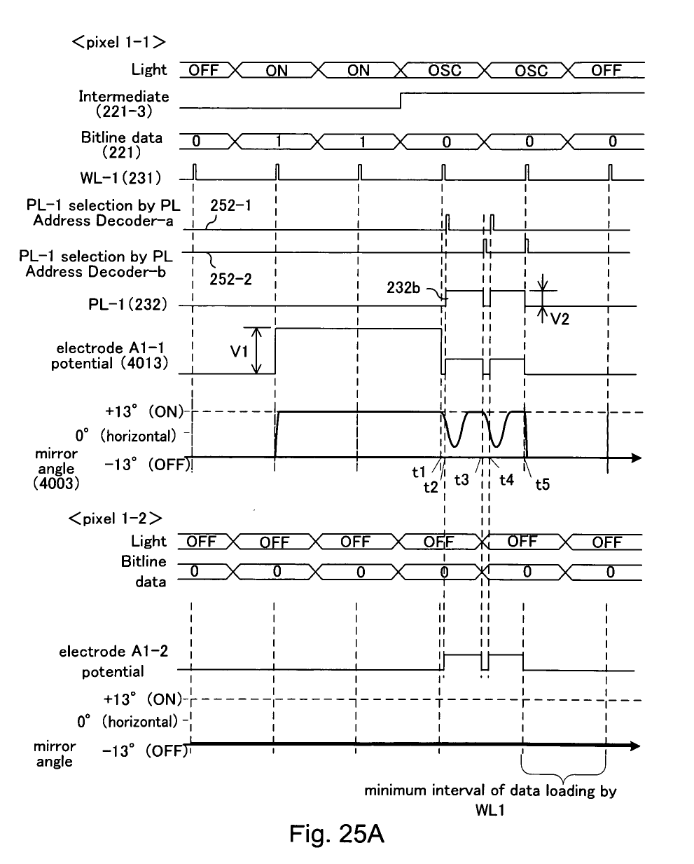

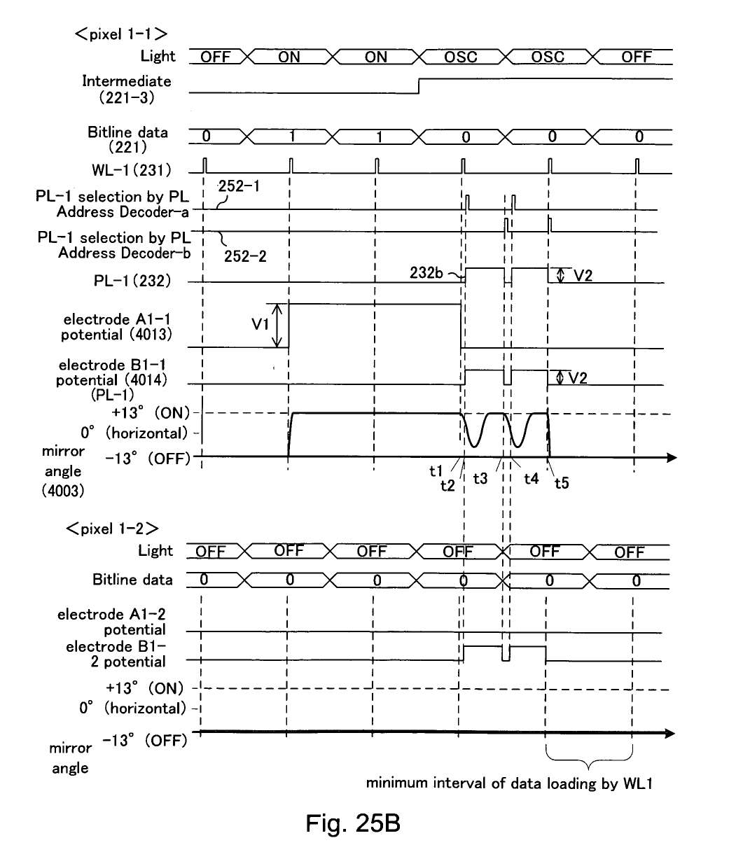

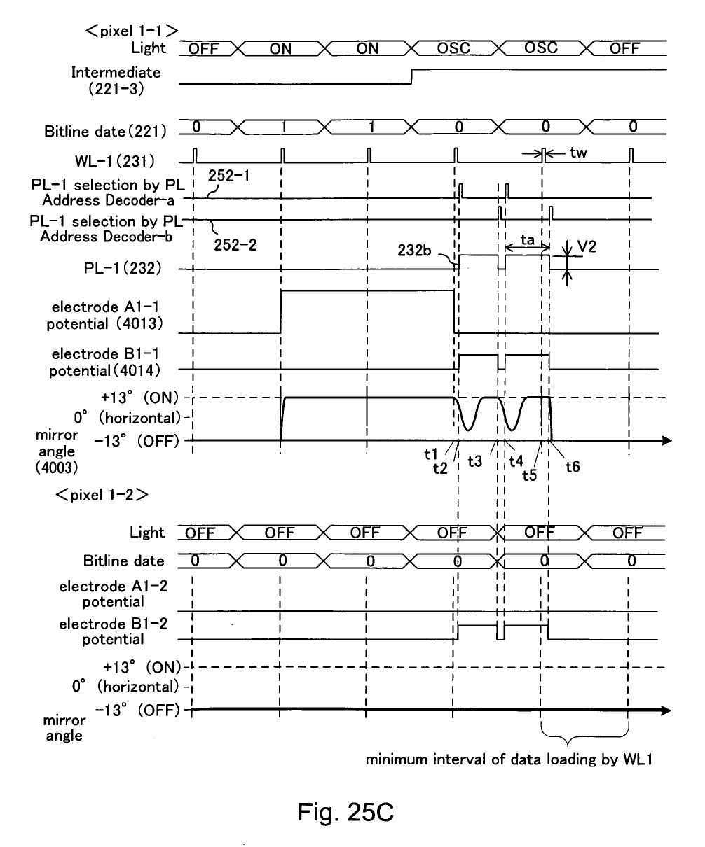

FIG. 25A is a timing chart depicting the state of the mirror and the operational timings of the <pixel 1-1> and <pixel 1-2> belonging to the same ROW line of the above described FIG. 24A.

In the example shown in FIGS. 24 and 25, <pixel 1-1> displays gray, while <pixel 1-2> displays black.

In this case, since <pixel 1-1> and <pixel 1-2> belong to the same ROW line, the mode changeover signal 221-3 (Intermediate), word line 231 (WL-1) and plate line 232 (PL-1) are common signals to the two of them.

Until the control timing t1, the mirror 4003 of the <pixel 1-1> is in PWM operation, and a voltage V1 in accordance with the bit line 221 (bitline) is applied to the electrode.

In this case, if the potential at the bit line 221 (bitline) is H level, the mirror 4003 is attracted to the address electrode 4013, abutting the insulation layer 4006 of the address electrode 4013, and is stationary. This is an ON state.

If the potential at the bit line 221 (bitline) is L level, the mirror 4003 separates from the address electrode 4013, abuts on the stopper 4002, and remains in that position. This is an OFF state.

Just prior to the control timing t1, the mirror 4003 is stationary in the ON state. Then, at the control timing t1, the voltage at the address electrode 4013 is changed by the bit line 221 (bitline) to be “0” volts (i.e., discharged), and the mirror 4003 starts to come off the address electrode 4013 by means of the elasticity of the elastic hinge 4007.

At the control timing t2, before the mirror 4003 is far from the address electrode 4013, the plate line address decoder 252-1 (PL Address Decoder-a) selects the plate line 232 (PL-1), and the plate line 232 (PL-1) is turned to be H level (i.e., a potential 232b, which is lower than the H level of the bit line 221). A voltage is generated at the electrode by the potential 232b so that the mirror 4003 is attracted by the address electrode 4013 and is stationary thereat.

At the control timing t3, the plate line address decoder 252-2 (PL Address Decoder-b) selects the plate line 232 (PL-1) and, if it is L level, the mirror 4003 starts to come off the address electrode 4013 again.

At the control timing t4, similar to the case at t2, the plate line address decoder 252-2 (PL Address Decoder-a) selects the plate line 232 (PL-1), and it is turned to H level (i.e., the potential 232b), and the mirror 4003 is re-attracted to the address electrode 4013 to be stationary thereat.

At the control timing t5, the plate line address decoder 252-2 (PL Address Decoder-b) selects the plate line 232 (PL-1), and the PL-1 is turned to L level so that the mirror 4003 is re-attracted by the address electrode 4013 to be stationary thereat. Simultaneously or a little thereafter, a memory cell is selected by the word line 231, and “0” volts is set by the bit line 221.

With this series of operations, the mirror 4003 is enabled to generate a smaller intensity of light than the intensity during the minimum data loading period in accordance with a PWM control with the word line 231 (WL) and express an intermediate gray scale.

In this case, the mirror of <pixel 1-2> adjacent to the <pixel 1-1> is to display black, and therefore, the mirror needs to be continuously stationary on the side of the stopper 4002 (i.e., the OFF side).

The plate line 232 (PL-1) is common to the <pixel 1-1> and <pixel 1-2>, and therefore, between the control timings t2 and t5, a voltage is generated at the address electrode 4013. However, the mirror 4003 is stationary on the OFF side. Because of the relatively great distance between the address electrode 4013 and mirror 4003, the Coulomb force applied to the mirror 4003 is small, causing no change to the position of the mirror 4003.

The control is such as to maintain the following relationship and the position of the mirror 4003:

[H level (V1) of the bit line 221 (Bitline)]>[H level (V2) of the PL]

As such, the spatial light modulator 200 comprising the mirror element 4011 is configured, as exemplified in FIGS. 23A and 23B, to control the mirror element 4011 with one memory cell M2, thereby making it possible to reduce the size of the mirror element 4011 and to express various gray scale by means of intermediate oscillation of the mirror 4003 using the plate line 232.

In a projection technique using the spatial light modulator 200, a reduction in the size of the mirror element 4011 makes it possible to obtain both a higher level of definition of the projection image by arraying a larger number of mirror elements 4011 and a higher grade of gray scale with the intermediate oscillation of the mirror 4003 using the plate line 232.

FIG. 24 B is a circuit diagram showing an exemplary modification of the circuit of the pixel array comprising a mirror (exemplified in FIG. 24A) that is structured as a cantilever.

The exemplary modification shown in FIG. 24B is different from the configuration of FIG. 24A in that the former is configured such that the second plate 216b-2, of a pair of plates constituting the ON capacitor 216b, is connected to the plate line 232.

Therefore, the present exemplary modification makes it possible to control the potential of the ON capacitor 216b not only by the potential of the bit line 221 but also by that of the plate line 232.

Further, the reference potential of the ON capacitor 216b, when the bit line 221 is active, can be discretionarily controlled from the plate line 232 instead of being limited by the ground potential, et cetera.

According to the present exemplary modification, the control timing of the potential of the ON capacitor 216b is similar to the case exemplified in FIG. 25A, in which the operation is carried out in such a manner that the potential of the ON capacitor 216b is controlled by making the plate line 232 active (i.e., the potentials change) during a period in which the bit line 221 is inactive (i.e., the potential is constant), and such that, conversely, the potential of the ON capacitor 216b is controlled by making the bit line 221 active (i.e., the potentials change) during a period in which the plate line 232 is inactive (i.e., the potential is constant).

Combining the potential control of the address electrode 4013 using the bit line 221 and plate line 232 makes it possible to attain a fine gray scale control for a projection image by combining the light intensity control for the reflection light from the incident light 511 by means of the ON/OFF control of the mirror 4003 and the light intensity control for the reflection light by means of an intermediate oscillation state between the ON and OFF states of the mirror 4003 without shortening, any more than necessary, the access cycle to the memory cell M2 constituted by the ON capacitor 216b and other components, that is, without a need to speed up, any more than necessary, the access operation to the memory cell M2.

Further, the voltage V1 when the bit line 221 is active and the voltage V2 when the plate line 232 is active are controlled so as to maintain the relationship of V1>V2. T the relationship between the H level of the bit line 221 (Bitline) and the H level of the plate line 232 (PL) may not necessarily be maintained as:

H level of the bit line 221 (Bitline)>H level of the plate line 232 (PL)

The reason is that a voltage drop of the gate transistor 216c and the relationship between the voltage of the plate line 232 (PL) and V2 are determined by the capacitance ratio of the floating capacitances (or stray capacitances) of the ON capacitor 216b and gate transistor 216c.

Therefore, the Coulomb force Fc1 acting on the mirror 4003 from the address electrode 4013, generated by the voltage V1 set to the ON capacitor 216b (that is, the address electrode 4013) from the bit line 221, is larger than the Coulomb force Fc2 acting on the mirror 4003 from the address electrode 4013, generated by the voltage V2 set to the ON capacitor 216b from the plate line 232.

That is, the Coulomb force Fc1 generated by the voltage V1 from the bit line 221 has a sufficient magnitude to tilt the mirror 4003 from the OFF position to ON position against the elasticity of the elastic hinge 4007.

In contrast, the Coulomb force Fc2 generated by the voltage V2 from the plate line 232 is not large enough to change the ON/OFF states of the mirror 4003 (that is, the ON/OFF states are not affected), and is rather just large enough to tilt the mirror 4003 in a transition state between the ON and OFF states.

Therefore, the combination between the ON/OFF operation of the mirror 4003 by the bit line controlling the potential of the address electrode 4013 and the oscillation control of the mirror 4003 by the plate line 232 controlling the potential of the address electrode 4013 makes it possible to attain a projection image in finer gray scale levels.

Further, the configuration in which the mirror 4003 is supported by the elastic hinge 4007 in a cantilever structure makes it possible to configure the area of the address electrode 4013 equipped under the mirror 4003, for example, as large as ½, or more, of the entire area of the mirror element 4011 (i.e., the pixel unit 211).

With this configuration, it is possible to increase the magnitude of the Coulomb force acting on the mirror 4003 from the address electrode 4013 without increasing the voltages V1 or V2 any more than necessary, and thereby, it is possible to reliably perform the ON/OFF operation of the mirror 4003 and the intermediate oscillation operation.

FIG. 24C is a circuit diagram showing an exemplary modification of the circuit of the pixel array comprising a mirror (exemplified in FIG. 24A) structured as a cantilever.

FIG. 25B is a timing chart corresponding to the exemplary modification shown in FIG. 24C.

The exemplary modification shown in FIG. 24C is configured to eliminate the above described second ON capacitor 233, equip a second address electrode 4014 in addition to the address electrode 4013, and connect the second address electrode 4014 to the plate line 232.

Also in this configuration, the period in which the potential of the address electrode 4013 is controlled by making the bit line 221 active and the period in which the potential of the second address electrode 4014 is controlled by making the plate line 232 active can be set to be mutually exclusive so that the two periods will not overlap.

As exemplified in FIG. 25B, the plate line 232 is inactive during the period in which the bit line 221 is active (“1”), while the plate line 232 is active during the period in which the bit line 221 is inactive.

Further, the voltage V1 set to the address electrode 4013 from the bit line 221 is larger than the voltage V2 set to the address electrode 4014 from the plate line 232.

Specifically, the Coulomb force Fc1 generated by the voltage V1 from the address electrode 4013 is larger than the Coulomb force Fc2 generated by the voltage V2 and from the second address electrode 4014.

The voltage V1 and voltage V2 are set such than the Coulomb force Fc1 is large enough to control the ON/OFF states of the mirror 4003 against the elasticity of the elastic hinge 4007, whereas the Coulomb force Fc2, smaller than Coulomb force Fc1, affects only the transition state between the OFF and ON states of the mirror 4003.

With this control, a combination between the ON/OFF control of the mirror 4003 using the bit line 221 and word line 232 (i.e., the address electrode 4013) and the intermediate oscillation control between the ON and OFF states of the mirror 4003 using the plate line 232 (i.e., the second address electrode 4014), it is possible to attain a finer gray scale control of a projection image without the need to speed up, for example, the memory cell M2 any more than necessary.

FIG. 25C is a timing chart showing the exemplary modification of the control exemplified in FIG. 25B.

FIG. 25C exemplifies the case of a control in which at control timing t5, the tail end of the active period ta (i.e., a period in which the potential 232b is at the voltage V2), the plate line 232 crosses the word line active period tw next to the word line 231 and extends to control timing t6.

Note that the example shown in FIG. 25C shows the case in which the active period ta of the plate line 232 completely overlaps with the word line active period tw and extends to the next access cycle. However, it is also possible control in such a manner that the tail end (at the control timing t6) of the active period ta of the plate line 232 partly overlaps with the active period tw of the word line.

As shown in FIG. 25C, if the active period ta of the plate line 232 completely overlaps with the active period tw of the word line, the timing of the mirror 4003 shifting to the OFF state can be determined by the plate line 232.

Further, if the active period ta of the plate line 232 partly overlaps with the active period tw of the word line, the mirror 212 shifting to the OFF state can be controlled accurately by the control timing t5 of the word line 231 even if the control timing t6 that determines the tail end of the active period ta of the plate line 232 fluctuates.

As in the exemplary modification shown in FIG. 24C, the configuration in which the second address electrode 4014 is equipped in addition to the address electrode 4013, with the second address electrode 4014 connected to the plate line 232, the control timing of the voltage V2 for the second address electrode 4014 can be set independently from the control timing of the memory cell M2 for the second address electrode 4014.

In this configuration, no circuit elements, such as capacitor, are placed between the second address electrode 4014 and plate line 232, minimizing a stray capacitance, and therefore the access speed from the plate line 232 to the second address electrode 4014 can be increased.

Similarly, no circuit elements, such as transistor, are placed between the second address electrode 4014 and plate line 232, eliminating a limit in the withstanding voltage, and therefore, a relatively high discretionary voltage can be applied to the second address electrode 4014 from plate line 232.

Further, the exemplary modification shown in FIG. 24C is also configured such that the mirror 4003 is supported by the elastic hinge 4007 in a cantilever structure, and therefore it is possible to set the total area of the address electrode 4013 and second address electrode 4014 under the mirror 4003 as large as, for example, ½ or more of the entire area of the mirror element 4011 (i.e., the pixel unit 211).

With this configuration, it is possible to increase the magnitude of the Coulomb force acting on the mirror 4003 from the address electrode 4013 and second address electrode 4014 without increasing the voltages V1 or V2 any more than necessary, and thereby, it is possible to reliably perform the ON/OFF operation of the mirror 4003 and the intermediate oscillation operation.

The configurations shown in FIGS. 24A through 24C makes it possible to drive the mirror with one memory cell M2, as compared to two memory cells according to the conventional technique, creating a free space in the MOS region of the pixel, thereby providing the following benefits. First of all, the size of the gate transistor 216c may be increased, which improves the withstanding voltage. A high drive voltage enables a high speed operation of the mirror even if the hinge is strengthened as a countermeasure to stiction.

Meanwhile, configuring each of the ON capacitor 216b and second ON capacitor 233 as a poly-capacitor (MOS capacitor), using poly-silicon for the first plate 216b-1, second plate 216b-2, the first plate 233-1, and second plate 233-2, instead of as aluminum capacitors using aluminum for the aforementioned plates, makes it possible to eliminate the number of masks required for the production process using a photolithography process for the spatial light modulator 200.

Further, if the ON capacitor 216b and second ON capacitor 233 are configured as the same poly-capacitors, the voltage retention time of the memory cell increases with the area, making it possible to slow down the cycle of writing to the memory cell.

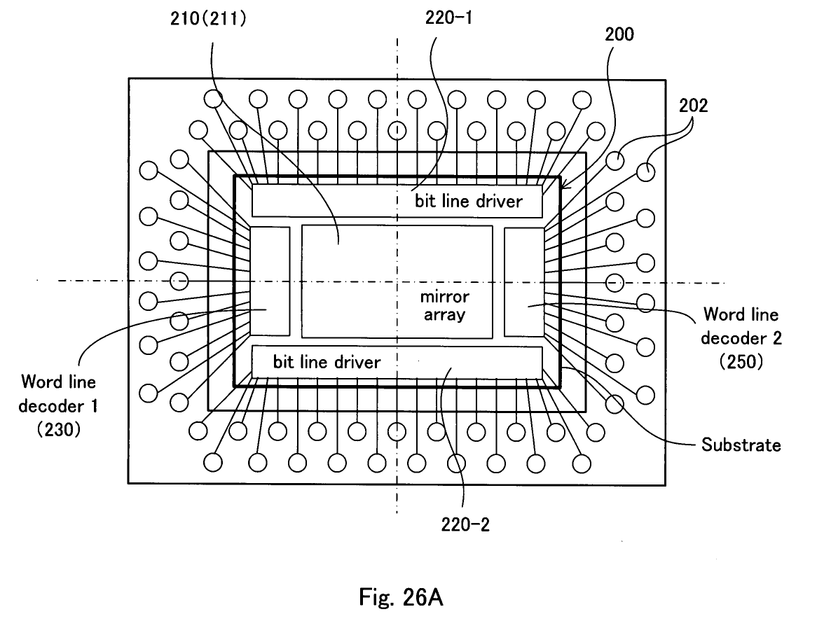

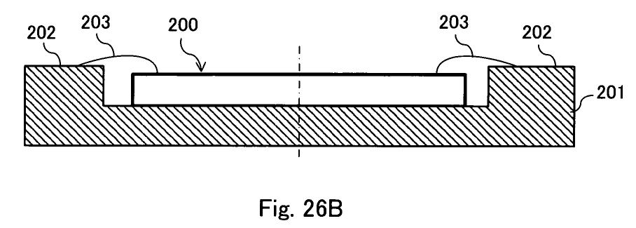

FIG. 26A is a top view diagram exemplifying the structure of a package accommodating the spatial light modulator exemplified in FIGS. 22A through 22D, et cetera; FIG. 26B is its cross-sectional diagram.

The spatial light modulator 200 according to the present embodiment is configured to place the upper bit line driver part 220-1 and lower bit line driver part 220-2 along the upper and lower sides, respectively, which are parallel to the ROW line in the surrounding area of the pixel array 210, and to place the word line driver unit 230 and plate line driver unit 250 along the left and right sides, respectively, which cross the aforementioned upper and lower sides.

The spatial light modulator 200 is accommodated in the concave part 201a of the package 201.

A plurality of bonding pads 202 is placed in the area surrounding the concave part 201a of the package 201.

Then, the bit lines and address lines equipped in the upper bit line driver part 220-1, lower bit line driver part 220-2, word line driver unit 230 and plate line driver unit 250 are respectively connected, by way of the bonding wires, to the bonding pads 202 provided in the surrounding area, and are further connected electrically, by way of external connection electrodes (not shown in drawing) that are equipped on the bottom part of the package 201, to the wiring board or the like of a projection apparatus incorporating the package 201.

Next is a description of further specific exemplary configuration of a projection apparatus comprising the spatial light modulator 200 equipped with the above described plate line 232. Note that the designations corresponding to the previously described constituent components are noted in the drawing with a corresponding designation in parenthesis as appropriate.

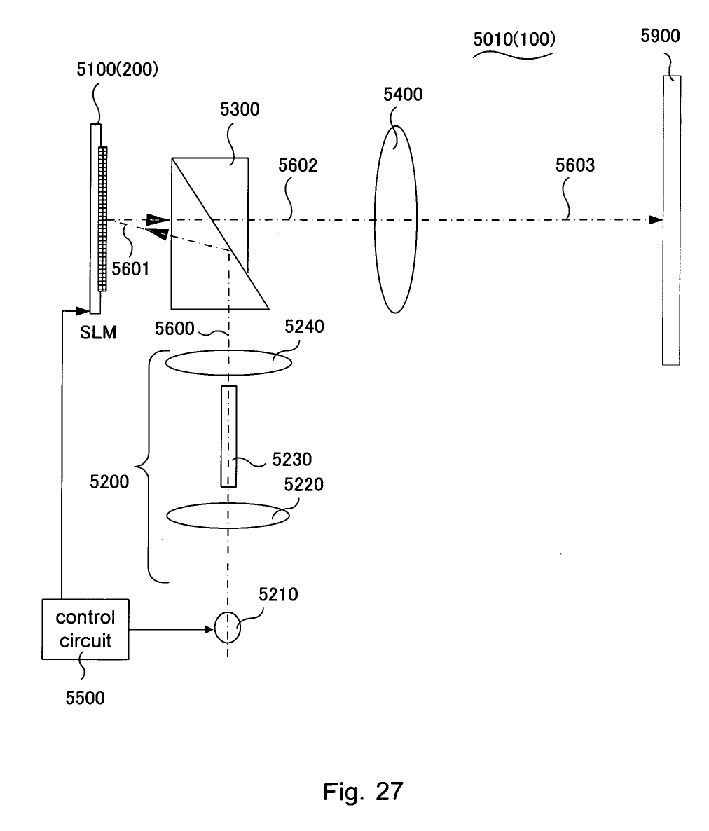

FIG. 27 is a functional block diagram showing the configuration of a projection apparatus according to a preferred embodiment of the present invention.

As exemplified in FIG. 27, a projection apparatus 5010 according to the present embodiment comprises a single spatial light modulator (SLM) 5100 (i.e., the spatial light modulator 200), a control unit 5500 (i.e., the control apparatus 300), a Total Internal Reflection (TIR) prism 5300, a projection optical system 5400, and a light source optical system 5200.

The spatial light modulator 5100 is constituted by the above described spatial light modulator 200 comprising the plate line 232.

The projection apparatus 5010 is a so-called single-panel projection apparatus 5010 comprising a single spatial light modulator 5100.

The projection optical system 5400 is equipped with the spatial light modulator 5100 and TIR prism 5300 in the optical axis of the projection optical system 5400, and the light source optical system 5200 is equipped in such a manner that the optical axis matches that of the projection optical system 5400.

The TIR prism 5300 causes the illumination light 5600, incoming from the light source optical system 5200 placed onto the side, to enter the spatial light modulator 5100 at a prescribed inclination angle as incident light 5601 and causes a reflection light 5602, reflected by the spatial light modulator 5100, to transmit to the projection optical system 5400.

The projection optical system 5400 projects the reflection light 5602 as projection light 5603 to a screen 5900.

The light source optical system 5200 comprises a variable light source 5210 for generating the illumination light 5600, a condenser lens 5220 for focusing the illumination light 5600, a rod type condenser body 5230, and a condenser lens 5240, all of which are sequentially placed in the aforementioned order in the optical axis of the illumination light 5600, which is emitted from the variable light source 5210 and incident to the side face of the TIR prism 5300.

The projection apparatus 5010 employs a single spatial light modulator 5100 for implementing a color display on the screen 5900 by means of a sequential color display method.

Specifically, the variable light source 5210, comprising a red laser light source 5211, a green laser light source 5212 and a blue laser light source 5213 (which are not shown in the drawing), allows independent controls for the light emission states and divides one frame of display data into a plurality of sub-fields (i.e., three sub-fields, that is, red (R), green (G) and blue (B) in the present case). It further causes each of the red 5211, green 5212 and blue 5213 laser light sources to emit each respective light in a time series at the time band corresponding to the sub-field of each color, as described later.

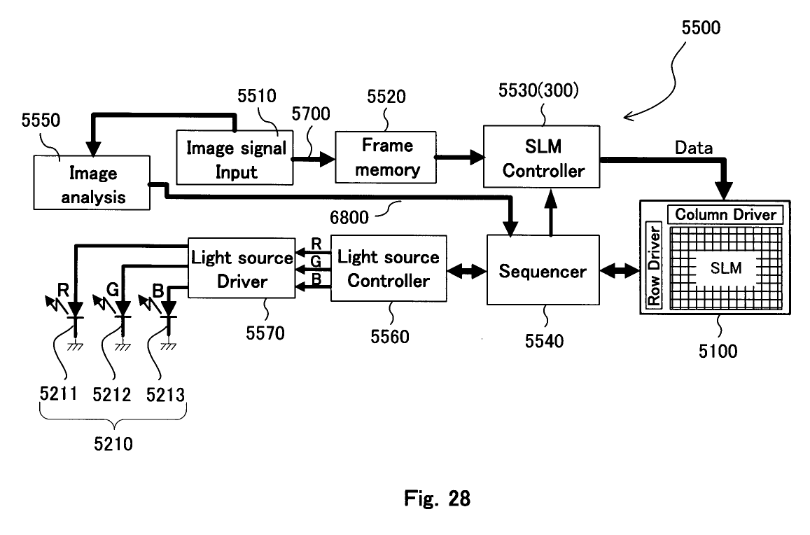

FIG. 28 is a functional block diagram for showing a configuration of the control unit 5500 implemented in the above described single-panel projection apparatus 5010. The control unit 5500 comprises a frame memory 5520, an SLM controller 5530, a sequencer 5540, a light source control unit 5560 and a light source drive circuit 5570.

The sequencer 5540, includes a microprocessor to control the operation timing of the entire control unit 5500 and the spatial light modulators 5100.

In one exemplary embodiment, the frame memory 5520 retains one frame of input digital video data 5700 received from an external device (not shown in the figure) connected to a video signal input unit 5510. The input digital video data 5700 is updated in real time whenever the display of one frame is completed.

The SLM controller 5530 processes the input digital video data 5700 read from the frame memory 5520, as described later. The SLM controller separates the data, read from the memory 5520, into a plurality of sub-fields according to detailed descriptions below. The SLM controller outputs the data subdivided into subfields to the spatial light modulators 5100 as binary data 5704 and non-binary data 5705, which are used for implementing an the ON/OFF control and oscillation control (which are described later) of a mirror 5112 of the spatial light modulator 5100.

The sequencer 5540 outputs a timing signal to the spatial light modulators 5100 in sync with the generation of the binary data 5704 and non-binary data 5705 at the SLM controller 5530.

The video image analysis unit 5550 outputs a image analysis signal 5800 used for generating various light source pulse patterns (which are described later) corresponding to the input digital video data 5700 inputted from the video signal input unit 5510.

The light source control unit 5560 controls, by way of the light source drive circuit 5570, the operation of the variable light source 5210 emitting the illumination light 5600 on the basis of the video image analysis signal 6800 obtained from the video image analysis unit 5550, by way of the sequencer 5540.

The light source drive circuit 5570 drives the red laser light source 5211, green laser light source 5212 and blue laser light source 5213 of the variable light source 5210 to emit light on the basis of instruction from the light source control unit 5560.

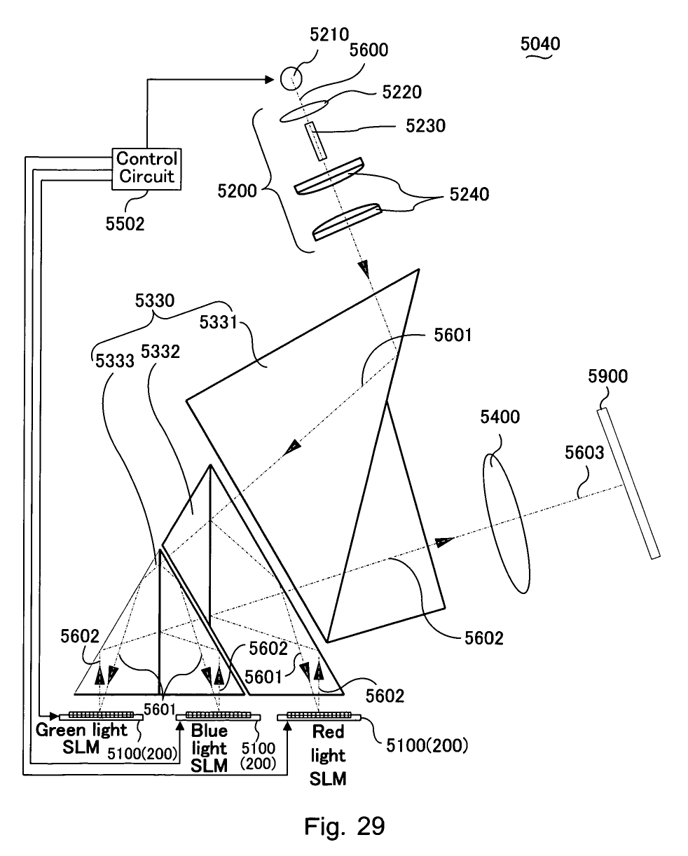

FIG. 29 is a functional block diagram showing another exemplary modification of a multi-panel projection apparatus according to the present embodiment.

The projection apparatus 5040 is configured to position, so as to be adjacent to one another in the same plane, a plurality of spatial light modulators 5100 (i.e., the spatial light modulators 200) corresponding to the three colors R, G and B on one side of a light separation/synthesis optical system 5330.

This configuration makes it possible to consolidate a plurality of spatial light modulators 5100 into the same packaging unit, for example, a package 201, thereby saving space.

The light separation/synthesis optical system 5330 comprises a TIR prism 5331, a TIR prism 5332 and a TIR prism 5333.

The TIR prism 5331 has the function of guiding illumination light 5600, incident in the lateral direction of the optical axis of the projection optical system 5400, to the spatial light modulators 5100 as incident light 5601.

The TIR prism 5332 has the functions of separating red light from the incident light 5601 and guiding it to the red color-use spatial light modulator 5100 and also of capturing the reflection light 5602 of the separated incident light and guiding it to the projection optical system 5400.

Likewise, the TIR prism 5333 has the functions of separating the incident green and blue lights from the incident light 5601, making them incident to the individual spatial light modulators 5100 equipped correspondently to the each color, and of capturing the reflection lights 5602 of the respective colors to guide them to the projection optical system 5400.

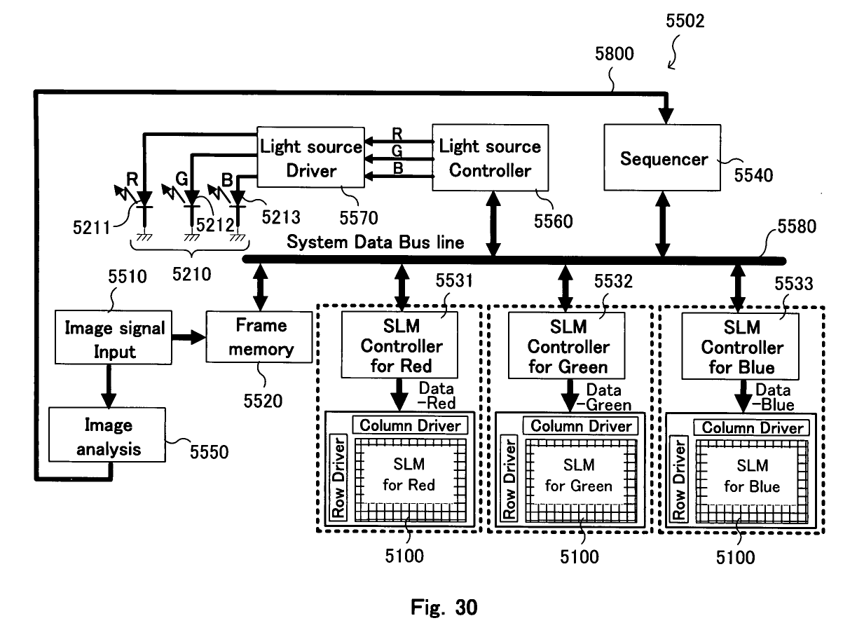

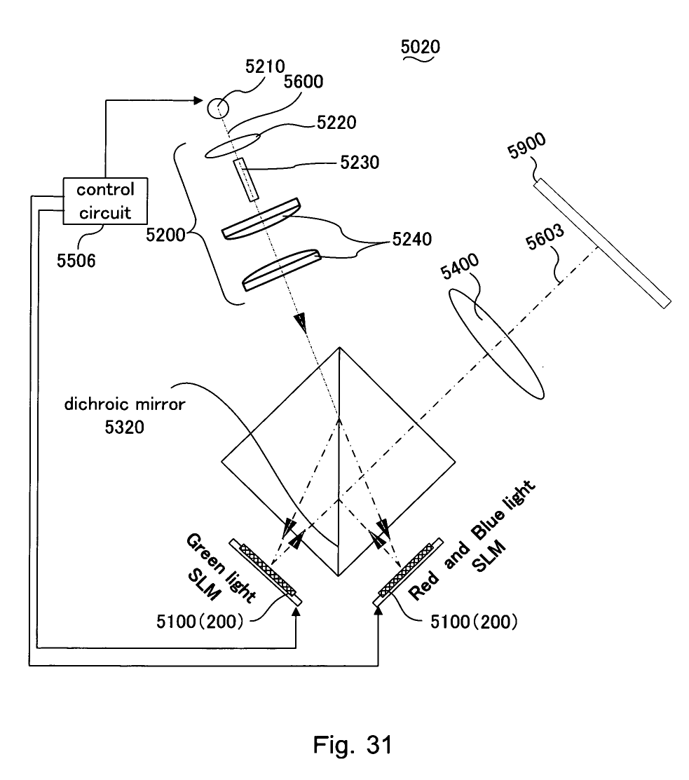

FIG. 30 is a functional block diagram showing an exemplary configuration of the control unit of a multi-panel projection apparatus according to the present embodiment.

The control unit 5502 comprises a plurality of SLM controllers 5531, 5532 and 5533 used for controlling each of the spatial light modulators 5100 equipped for the respective colors R, G and B, and the configuration of the controllers is the main difference from the above described control unit 5500.

Specifically, each of the SLM controller 5531, SLM controller 5532 and SLM controller 5533, is implemented to process the modulation of a specific color, Red, Green, and Blue. Each modulator is supported on the same substrate as those of the other spatial light modulators 5100. This configuration makes it possible to place the individual spatial light modulators 5100 and the corresponding SLM controller 5531, SLM controller 5532 and SLM controller 5533 close to each other, thereby enabling a high speed data transfer rate.

Further, a system bus 5580 is used to connect the frame memory 5520, light source control unit 5560, sequencer 5540 and SLM controllers 5531 through 5533, in order to speed up and simplify the connection path of each connecting element.

FIG. 31 is a functional block diagram showing an exemplary modification of a multi-panel projection apparatus according to another preferred embodiment of the present invention.

An exemplary case of the projection apparatus 5020 shown in FIG. 31 is equipped with two spatial light modulators 5100 (i.e., the spatial light modulators 200), each of which comprises the above described plate line 232. One spatial light modulator 200 modulates the green light, while the other spatial light modulator 200 modulates the red and blue lights.

The projection apparatus 5020 comprises a dichroic mirror 5320 as a light separation/synthesis optical system. The dichroic mirror 5320 separates the wavelength component of green light and the wavelength components of red and blue lights from the incident light 5601 from the light source optical system 5200, causing them to branch into the two spatial light modulators 200, respectively. The dichroic mirror 5320 further synthesizes the reflection lights 5602 of the green light with the reflection lights of the red and blue light, each reflected (i.e., modulated) by the corresponding spatial light modulators 200, to guide the synthesized light to the optical axis of the projection optical system 5400, which projects the synthesized light onto a screen 5900 as projection light 5603.

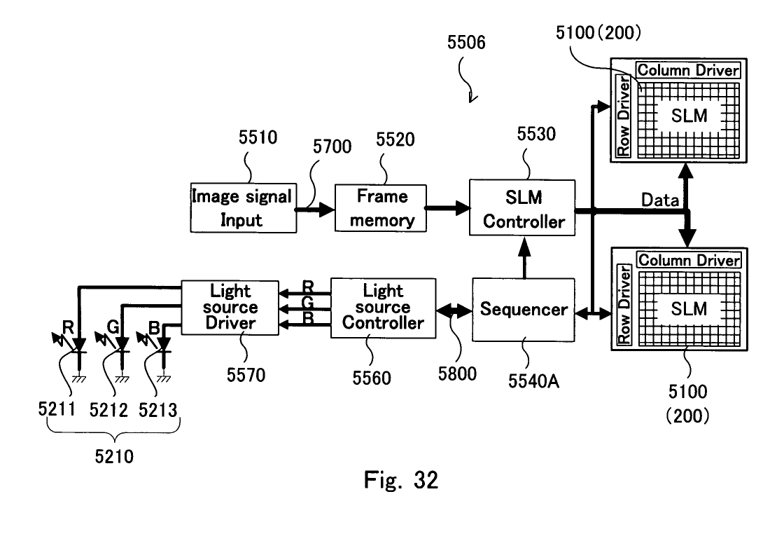

FIG. 32 is a functional block diagram showing an exemplary configuration of a control unit 5506 equipped in the projection apparatus 5020 comprising the above described two spatial light modulators 200. In this case, the SLM controller 5530 controls two spatial light modulators 5100 (i.e., the spatial light modulators 200), which is the only difference from the configuration shown in FIG. 28.

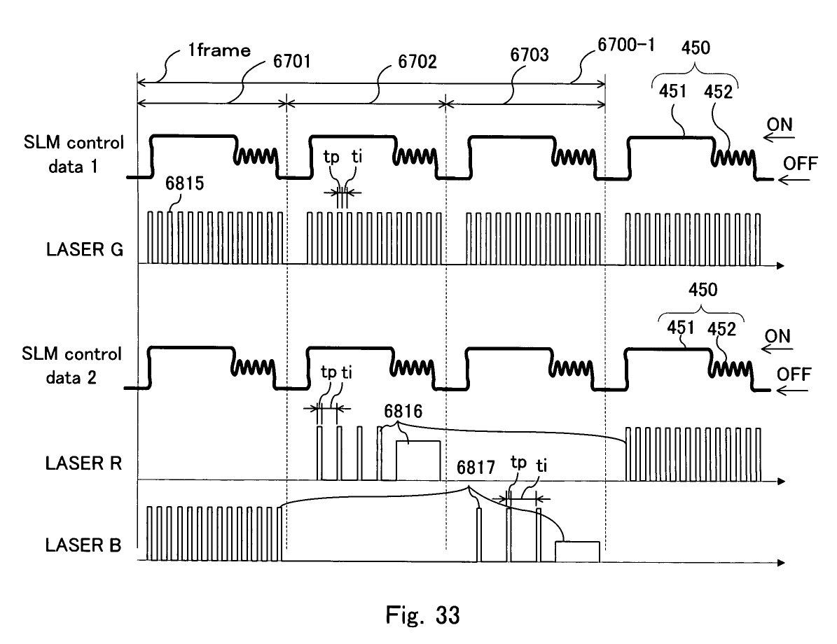

FIG. 33 is a chart showing the waveform of a control signal of the projection apparatus according to the present embodiment.

A drive signal (i.e., a mirror control profile 450 shown in FIG. 33) generated by the SLM controller 5530 drives a plurality of spatial light modulators 5100.

The light source control unit 5560 generates a light source profile control signal 5800 corresponding to the mirror control profile 450, a signal for driving an individual spatial light modulators 5100, and inputs the generated signal to the light source drive circuit 5570, which then adjusts the intensity of the laser light (i.e., the illumination light 5600) emitted from each of the red 5211, green 5212 and blue 5213 laser light source.

The control unit 5506 comprised in the projection apparatus 5020 is configured such that a single SLM controller 5530 drives the plurality of spatial light modulators 5100, thereby enabling the irradiation of the illumination light 5600 on the respective spatial light modulators 5100 with the optimal intensity of light without the need to comprise a light source control unit 5560 or light source drive circuit 5570 for each spatial light modulator 5100. This configuration simplifies the circuit configuration of the control unit 5506.

As shown in FIG. 33 the light source control unit 5560 and light source drive circuit 5570 drives the red 5211, green 5212 and blue 5213 laser light source so as to adjust the intensities of individual lasers (i.e., illumination light 5600) of the colors R, G and B in synch with the respective SLM drive signals (i.e., the mirror control profile 450) that is generated by the SLM controller 5530.

In this case, two colors R and B share one spatial light modulator 5100, and therefore, the control is a color sequential method.

Specifically, one frame is constituted by a plurality of subfields, that is, subfields 6701, 6702 and 6703, and the same light source pulse pattern 6815 is repeated in each subfield in one spatial light modulator 5100 corresponding to green (G).

Meanwhile, for the red (R) and blue (B) lights that share one spatial light modulator 5100, the pulse emission of the red laser light source 5211 and blue laser light source 5213 are respectively controlled so that the subfields, that is, subfields 6701 through 6703, are alternately used in a time series as indicated by the light source pulse pattern 6816 and light source pulse pattern 6817.

Further, in this case, the emission pulse intervals t1 and emission pulse widths tp can be changed in each of the light source pulse pattern 6815 of the green laser, the light source pulse pattern 6816 of the red laser, and the light source pulse pattern 6817 of the blue laser.

The present embodiment improves the quality of image display by increasing the levels of gray scale for each of the colors R, G and B.

The present invention discloses a technique for increasing the definition of the projection image while improving the resolution and the levels of gray scale thereof in a projection technique using a spatial light modulator.

Although the present invention has been described in terms of the presently preferred embodiment, it is to be understood that such disclosure is not to be interpreted as limiting. Various alternations and modifications will no doubt become apparent to those skilled in the art after reading the above disclosure. The present invention may be changed in various manners possible within the scope of the present invention, and is not limited to the configurations shown in the above-described embodiments. Accordingly, it is intended that the appended claims be interpreted as covering all alternations and modifications as fall within the true spirit and scope of the invention.

What is claimed is:

1. A spatial light modulator, comprising:
a pixel array comprising a plurality of pixel elements;
a plurality of word lines each connected to a row of pixel elements;
a plurality of plate lines; and
a plurality of bit lines each connected to a column of pixel elements, wherein each of the pixel elements further comprises a memory and an electrode connected to the memory, wherein the memory is connected to the word line and the plate line.

2. The spatial light modulator according to claim 1, wherein:
the memory includes a capacitor including a first plate and a second plate in a pair wherein the first plate of the capacitor connected to the electrode and the second plate connected to the plate line.

3. The spatial light modulator according to claim 1, wherein:
the memory includes a plurality of capacitors, each capacitor comprises a pair of a first plate and a second plate with the first plate connected to the electrode and the second plate of a first group of capacitors connected to a fixed potential and the second plate of a second group of the capacitors connector to the plate line.

4. The spatial light modulator according to claim 1, wherein:
the plate line is activated during a period when the memory is not receiving data from the word line for storing in the memory.

5. The spatial light modulator according to claim 1, wherein:
a Coulomb force generated from activating the electrode by signals transmitted through the plate line is smaller than a Coulomb force generated from activating the electrode by signals transmitted through the bit line.

6. The spatial light modulator according to claim 1, wherein:
each of the pixel elements is controllable to operate in mutually different first and second states and a third state as an intermediate state between the first and second states, wherein a Coulomb force generated by activating the electrode by signals transmitted through the plate line is applied only to control the pixel element operated in the third state and having no effect in operating in the first state or the second state.

7. The spatial light modulator according to claim 1, wherein:
the plate line is controlled to repeatedly activate and deactivate during a period when the memory is not receiving data from the word line for storing in the memory.

8. The spatial light modulator according to claim 1, wherein:
the plate line is deactivated during a period when the memory is receiving data from the word line for storing in the memory.

9. The spatial light modulator according to claim 1, wherein:
each of said pixel elements comprises a mirror controllable to tilt to different directions by generating a Coulomb force by applying a voltage to the electrode.

10. The spatial light modulator according to claim 1, wherein:
the area of the electrode is larger than one half of the area of the pixel element.

11. The spatial light modulator according to claim 2, wherein:
the first and second plates of the capacitor further comprising a first and a second electrode plates composed of aluminum.

12. The spatial light modulator according to claim 2, wherein:
the first and second plates of the capacitor further comprising a first and a second electrodes plates wherein at least one of said electrode plates comprises a polysilicon plate.

13. The spatial light modulator according to claim 1, wherein:
the memory includes a transistor having an area larger than one half of the area of the pixel element.

14. A spatial light modulator, comprising:
a plurality of pixel elements configured as a pixel array;
a plurality of word lines each connected to a row of pixel elements;
a plurality of plate lines; and
a plurality of bit lines each connected to a column of pixel elements, wherein each of the pixel elements further comprises a memory connected to a first electrode and said plate line connected to a second electrode.

15. The spatial light modulator according to claim 14, wherein:
the pixel elements comprising the second electrode connected to the plate line are disposed along a row in a direction along the word line.

16. The spatial light modulator according to claim 14, wherein:
a Coulomb force generated from activating the first electrode connected to the memory is larger than a Coulomb force generated from activating the second electrode connected to the plate line.

17. The spatial light modulator according to claim 14, wherein:
the pixel elements are controlled to operate in mutually different first and second states and a third state as an intermediate state between the first and second states, wherein a Coulomb force generated by activating the second electrode by signals transmitted through the plate line is applied only to control the pixel element operated in the third state and having no effect in operating in the first state or the second state.

18. The spatial light modulator according to claim 14, wherein:
the plate line is deactivated during a period when the memory is receiving data from the word line for storing in the memory.

19. The spatial light modulator according to claim 14, wherein:
the plate line is activated straddling a period when the memory is receiving data from the word line for storing in the memory.

20. The spatial light modulator according to claim 14, wherein:
each of said pixel elements comprises a mirror controllable to tilt to different directions by generating a Coulomb force by applying a voltage to the first and/or second electrode.

21. The spatial light modulator according to claim 14, wherein:
the total of the area of the first and second electrodes is larger than one half of the area of the pixel element.

22. The spatial light modulator according to claim 1, wherein:
the memory includes a pair of plates composed of an aluminum constituting a capacitor for the memory.

23. The spatial light modulator according to claim 1, wherein:
the memory includes a pair polysilicon layers constituting a capacitor.

24. The spatial light modulator according to claim 1, wherein:
the memory includes a transistor having an area larger than one half of an area of the pixel element.
